(19) United States
(12) Patent Application Publication
(10) Pub. No.: US 2007/0277130 A1
(43) Pub. Date: Nov. 29, 2007

(54) System and method for architecture verification

(76) Inventor: Evan Lavelle, (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/581,800

(22) PCT Filed: Dec. 2, 2004
(86) PCT No.: PCT/GB04/05053

§ 371 Date: Apr. 12, 2007

(30) Foreign Application Priority Data
Dec. 3, 2003 (GB) 0327959.3

(51) Int. Cl. G06F 17/50

(52) U.S. Cl. 716/4; 716/5

(57) ABSTRACT

A Verification environment, comprising a testbench and a test harness, which is used to automatically verify the operation of a processor device as described by a hardware description language (HDL) against the desired operation as specified by the instruction set architecture (ISA). Also described is a method of generating test instructions for use in such a system, in which the verification environment selects an instruction from the processor specification in accordance with one or more first constraints, then configures and encodes this instruction in accordance with one or more second constraints.

### FIELD OF THE INVENTION

This invention relates in general to system and architecture verification, and in particular to the automated verification of central processing units (CPUs).

### BACKGROUND AND PRIOR ART KNOWN TO THE APPLICANT

When developing new electronic systems it is necessary to create a specification, to design the system, and to verify that the system conforms to the specification. It may also be necessary to create certain software tools to allow the system to be used. This process is described below with reference to the development of a processor, or CPU, although it will be clear that the description is generally applicable to any electronic systems development.

It is customary to develop new processors in a number of separate steps. First, the processor is specified in terms of an Instruction Set Architecture (ISA), which specifies, among other things, the action of each of the processor's instructions. Second, the processor is designed, normally by manually creating a ‘Hardware Description Language’ (HDL) description of the processor. Third, it is determined whether or not the HDL description of the processor actually conforms to the ISA specification, in a process known as ‘verification’ or ‘validation’. It is at this stage that errors in either the specification, or the HDL description, or both, are found and fixed. Fourth, a set of development tools, such as a compiler, assembler, linker, simulator, and debugger are created. These four processes are normally iterated in a cycle known as ‘Design Space Exploration’ (DSE), until the target requirements for the processor have been met.

The processor is implemented as a physical device only when the verification process is complete. This final step is largely automated, and is carried out by tools which synthesize the processor's HDL description, to create a layout of the resulting electronic components, which can be etched onto a semiconductor device. This final implementation step is costly, time-consuming, and error-prone. It is therefore essential to put as much development effort as is practical into the pre-implementation stages, to increase confidence that the implementation stage will be successful.

The entire development cycle for a typical new processor, comprised of the pre-implementation stages described above, may take several hundred man years to complete. Even a relatively simple processor may require several man years of development work. Industry estimates on how this effort breaks down differ, but it is generally accepted that the ‘design’ of the processor takes a relatively small part of the total, while the processor's verification may take a very much larger fraction of the total development effort. Current estimates from a number of sources are that the verification may consume between 60% and 85% of the total project effort, and that this percentage is increasing with time.

These factors mean that the resources required to develop a new processor are generally beyond all but the largest organizations, although many more organizations would benefit from the ability to design their own custom processors. There are a number of specific reasons why the resources required are so extensive, including:
1 The four development stages—specification, design, verification, and tool development—are generally carried out sequentially, with limited overlap. This is because the stages depend upon each other. The design cannot be started without a specification, and the design cannot be verified until it is essentially complete. Similarly, tool chain development is often postponed until it is known whether or not the design will work.
2 There has been some limited progress towards the automated creation of RTL code from a processor specification, but the great majority of RTL code is still written by hand.
3 A processor design cannot be automatically verified against its specification. The verification process is still carried out manually, and the effort required to verify a new design increases exponentially as the design complexity increases. Some parts of the verification process, such as testbench and test program generation, can be automated, but this has little effect on the overall verification effort required.
4 Since design and verification are essentially carried out manually, any change in the processor specification can lead to extensive project delays, as the change is first manually implemented in the RTL, and then manually verified.

Whilst testbench and test program generators are well known in the art, a search of the literature has not revealed any tools that can perform the automated verification that is provided by the present invention.

Automatic testbench generators are in common use and are well known in the art. The popular ModelSim™ simulator, for example, includes an automatic testbench generator.

The use of automated test program generators in processor verification is well established. The processor test programs which are written by a verification engineer will fall into a spectrum starting with the traditional ‘fully directed’ test program, progressing through ‘directed random’, to ‘fully random’ test programs. At the start of this spectrum—at the ‘fully directed’ case—the program is manually written by the verification engineer, and tests a single highly specific part of the architecture. While progressing through the spectrum, test cases become less specific, but the level of automation in the creation of the test program increases. For all but the simple ‘fully directed’ case, the test program is created by a computer, using a test program generator, and the computer adds the required degree of randomness to select the desired point in the test program spectrum. Test programs in which the computer has added some degree of randomness are known as ‘pseudo-random test programs’.

A verification engineer ‘directs’ the test program generator towards a certain point on the test program spectrum by adding constraints to the generator. For this reason, the resulting test program is generally known as a ‘constrained pseudo-random test program’.

To be of maximum use, a test program must also be created in response to the current state of the processor. If a processor is currently in a supervisor mode, for example, then the generator should be capable of generating test code which includes privileged supervisor-mode instructions. The resulting test program is generally known as a ‘reactive constrained pseudo-random’ (RCPR) test program. In order to create reactive test programs, the generator must run in conjunction with a processor simulation, and the generator must be aware of the current state of the processor when it creates a new instruction.

It is clear that a RCPR program generator is invaluable when verifying processor architectures. A number of tools presently exist in order to assist in the generation of these test programs. One class of such tools are simply programming languages (such as Specman/‘e’, Vera, and SystemC). These languages contain constrained pseudo-random number generators, and so simply provide a framework in which the user could potentially write a RCPR program generator. These languages have no knowledge of a target architecture, and the process is therefore complex, time-consuming, and error-prone. The user must have a detailed knowledge of the target ISA, and must explicitly write program code embodying this knowledge. The resulting programs are not re-usable for different architectures, and require constant maintenance.

A second class comprises the RAVEN product from Obsidian Software and the Genesys-Pro product from IBM Corporation. RAVEN cannot be re-targeted through the use of a processor's ISA specification, and must be manually ported to new architectures. The generator must therefore effectively be re-written for each new architecture. RAVEN currently claims to support 9 proprietary architectures. The generator creates a test program, together with a listing of the expected results of the test program. Genesys-Pro uses an architecture description to allow the generator to be processor-independent, and so is re-targetable.

Whilst these two tools add different levels of automation to the RCPR program generation procedure they are mainly concerned with the creation of a test program, and not with the complete verification process. These generators therefore cannot be used directly in verification: the tools simply create a listing of the expected results of program execution, and the user must use these expected results in some unspecified way to confirm that their HDL architecture is functional.

Automatic software tool development from an Architecture Description Language (ADL) description has been implemented in a number of academic and commercial systems, and is well documented; see, for example, Ramsey et. al., “Machine Descriptions to Build Tools for Embedded Systems”, or Fauth et. al., “Describing Instruction Set Processors using nML”. These systems concentrate on the automated production of simulators and compilers, and are not applicable to RTL or HDL verification.

Automatic RTL generation has been implemented in, or claimed for, a number of academic and commercial systems; see, for example, Gupta et. al., “Auto Design of VLIW Processors” (U.S. Pat. No. 6,385,757), or Aditya, S., “Automatic architectural synthesis of VLIW and EPIC processors”.

The applicant is also aware of the following:

U.S. Pat. No. 6,477,683 (Tensilica). This makes use of the Vera programming language in order to generate random tests. There is little verification automation present, and the system is specific to the Xtensa processor, and not generic. The only expansion beyond the predefined Xtensa ISA is through so-called “TIE Instructions”, which are limited in scope.

The applicant further acknowledges the following: U.S. Pat. No. 5,815,688, US2003/0208723, U.S. Pat. No. 5,488,573, US2003/0208723 and U.S. Pat. No. 5,646,949.

The general aim of this invention—to improve processor verification quality and reduce verification time—is one recognized by several companies in the same field. However, they take different approaches to the present invention, and are directed at solving only individual problems of the many that exist in this field. The cited specifications each tackle elements of the processor verification problem, but none is as far reaching in scope or depth as the present invention. The present invention, on the other hand, is wide-ranging in its aims, and the specific approaches it takes to overcome problems—in particular the use of a specification to automatically generate the test environment—are not known. The applicant therefore believes that the invention disclosed in this specification involves several inventive steps, in view not only of the individual, innovative verification steps that comprise it, but also in view of the wide range of approaches that these steps cover, which combine to make a complete system of high innovation.

### SUMMARY OF THE INVENTION

According to a first aspect of the present invention there is provided a method of verifying a processor design against a processor specification, the method comprising the steps of a) creating a verification environment, b) executing an instruction sequence in a first simulation process; c) executing the same instruction sequence in a second simulation process; and d) comparing the results of the first simulation with the results of the second simulation in order to verify the processor design.

The first simulation process may comprise the execution of the instruction sequence according to the processor specification and the second simulation process may comprise the execution of the instruction sequence according to the processor design.

The processor specification may be a computer-readable description of the processor's Instruction Set Architecture (ISA), coded in an Architecture Description Language (ADL). The processor design may be expressed in a Hardware Description Language (HDL), written at any required abstraction level.

The invention comprises a verification environment, or “test harness”. The verification environment comprises the first simulation process, and a method for the comparison of the first and second simulation processes. According to this method, the verification environment defines a verifiable state for the processor, where the verifiable state comprises a plurality of verifiable elements from the processor specification.

The verifiable state is maintained within the verification environment, and both simulations will attempt to modify the verifiable state. The verification environment controls access to the verifiable state by queuing modification requests from the first simulation in a plurality of “specification pipelines”, and by queuing modification requests from the second simulation in a plurality of “design pipelines”.

The verification environment determines whether or not the requested changes in the plurality of pipelines are consistent, or could potentially become consistent at some point in the future. The verification environment is capable of doing this even for complex processor models, which implement speculative and out-of-order execution, and in the presence of asynchronous exceptions.

Further preferred features of the method are as follows:
The processor specification further comprises a description of any instructions which may be executed by the processor, preferably wherein each said instruction description comprises zero or more actions which define the instruction.
The processor specification further comprises a description of any stimuli which may cause an exception condition in the processor, preferably wherein each said stimulus description comprises zero or more actions which define the stimulus.
Where the processor specification comprises a plurality of verifiable elements, it is preferable that each of the verifiable elements is associated with a respective specification pipeline, and the method comprising the further step of executing the actions defining an instruction from the instruction sequence within the first simulation, the execution adding zero or more entries to the specification pipeline. Preferably also, each of the verifiable elements is associated with a respective design pipeline. Additionally, it is preferable that the method further comprising the step of executing the actions defining a stimulus, the execution adding zero or more entries to the specification pipeline.
In any aspect of the invention it is advantageous that the verification environment receives one or more notifications from the second simulation, the one or more notifications being generated by the operation of the second simulation. In this case, it is further preferred that the method comprises the additional steps of: the verification environment analyzing the one or more received notifications; and the verification environment generating one or more entries in one or more design pipeline(s) in response to the received notifications.
Also in any aspect of the invention, it is preferable that the method further comprises the step of the verification environment verifies each verifiable element for which the design pipeline or the specification pipeline comprise one or more entries, by comparing the respective pipelines. In this case, it is particularly preferred that the verification environment reports an error if the design pipeline can not be reconciled with the compared specification pipeline.
In any relevant aspect of the invention it is further preferred that the verification environment: identifies reconcilable entries within each pipeline; and acts on these entries by removing them from the design and specification pipelines and updating the state of the corresponding verifiable elements.
In any aspect of the invention, it is preferable that the verification environment analyses the processor specification to determine a plurality of processor memory elements, and more preferred that the verification environment further provides memory resources to the second simulation to implement the plurality of processor memory elements.

Included within the scope of the invention is a method of generating a configured instruction, the method comprising the steps of:
the verification environment receiving a request for a configured instruction and one or more parameters associated with the request;
the verification environment selecting one instruction from a processor specification comprising a plurality of instructions in accordance with one or more of a first set of constraints, in conjunction with a set of instruction attributes; and
the verification environment configuring and encoding the instruction in accordance with one or more of a second set of constraints, in conjunction with a set of instruction attributes.

Further preferred features of this method are as follows:
Preferably, the processor specification comprises the instruction attributes, and/or the attributes comprise one or more of the instruction bit fields, instruction name, instruction length, instruction encoding and pre-defined and user-defined properties.
Preferably, the verification environment selects a plurality of instructions and the configured instruction comprises this plurality of instructions.
Preferably, the first and second set of constraints comprise a set of probabilities for the selection and configuration of the instruction.
Preferably, the verification environment further comprises a simulation process wherein the request for an instruction is linked to the current state of the simulation process.

According to a further aspect of the present invention there is provided a method of pseudo-random instruction generation, the method comprising the steps of a) selection of an instruction from the processor specification according to a set of constraints provided by the user of the invention, and b) configuration of the selected instruction according to a further set of constraints provided by the user.

It is a primary advantage of some aspects of the present invention that the processor specification is used as a central resource to direct and control the verification and instruction generation processes.

It is a further advantage of some aspects of the present invention that pseudo-random instructions may be generated during the course of verification, thus providing ‘dynamic’ verification capability.

It is a further advantage of some aspects of the present invention that pseudo-random instructions may be generated in response to the current state of the first simulation, thus providing ‘dynamic reactive’ verification capability.

It is a further advantage of some aspects of the present invention that the verification environment requires no knowledge of the processor implementation beyond what is available in the processor specification, and so is completely reusable. The invention requires some minor modifications to the HDL code of the processor. These modifications take the form of calls to an API interface within the verification environment, and serve the purpose of informing the verification environment that the processor model wishes to change a part of the verifiable state.

It is a further advantage of some aspects of the present invention that the verification environment is also capable of implementing any memory regions which are required by the second simulation. These regions might be, for example, an L1 cache or a main memory. The memory is maintained in an efficient form which also allows verification of accesses to the memory.

It is a further advantage of some aspects of the present invention that the processor specification is used as a central resource to generate an HDL decoder for the processor.

It is a further advantage of some aspects of the present invention that the processor specification is used as a central resource, together with an additional ABI specification in some cases, to automatically create a set of development tools for the processor.

It is a further advantage of some aspects of the present invention that the processor specification forms a “golden reference” for the processor's architecture.

The invention will now be described, by way of example only, with reference to the following Figures, in which:

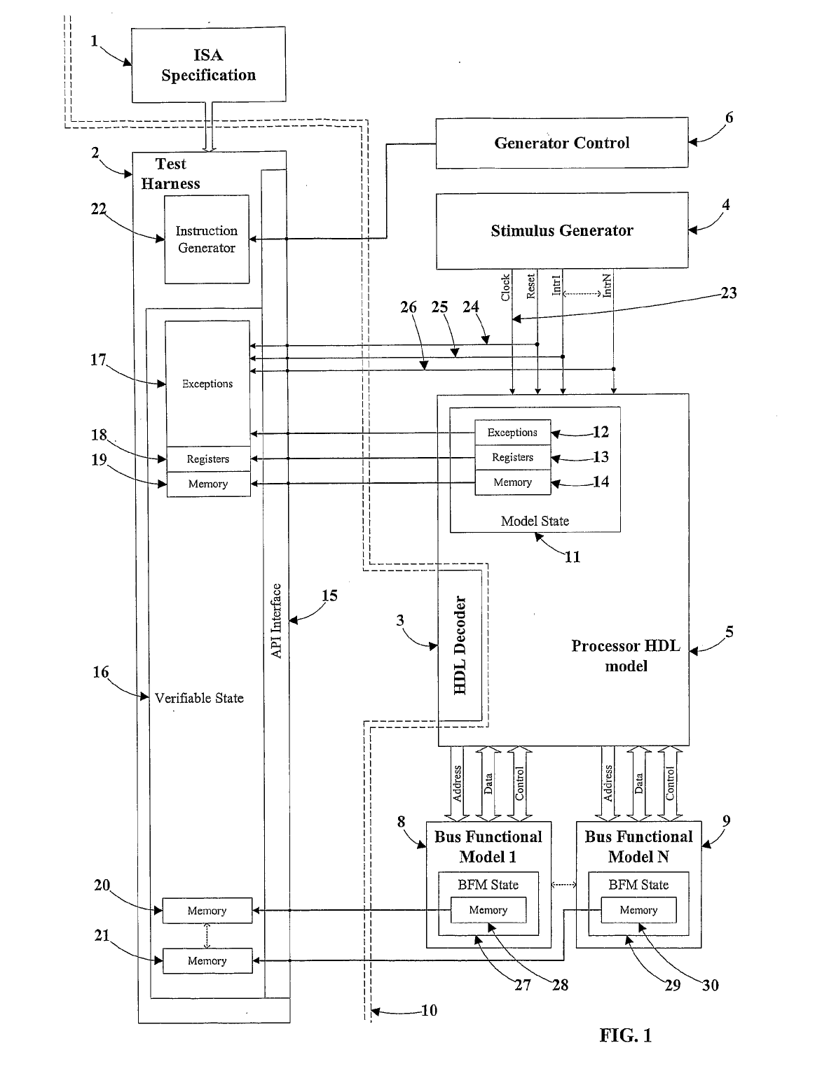

FIG. 1 is a block diagram of the major components of an ISA verification system according to a preferred embodiment of the present invention;

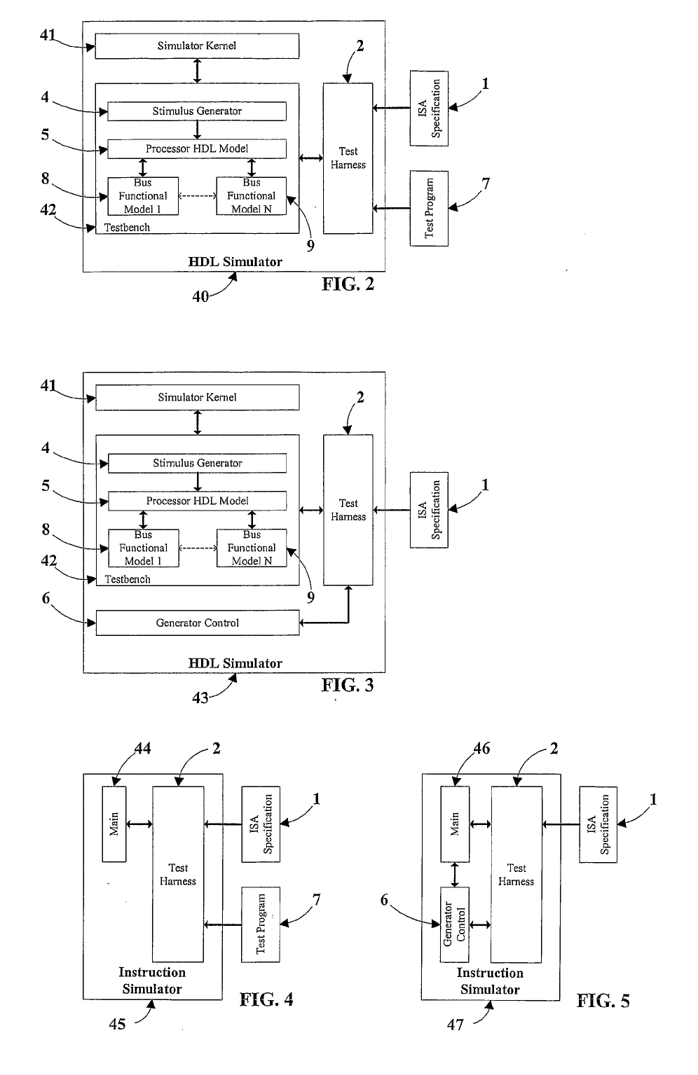

FIG. 2 is a block diagram of a static-mode HDL simulator according to a preferred embodiment of the invention;

FIG. 3 is a block diagram of a dynamic-mode HDL simulator according to a preferred embodiment of the invention;

FIG. 4 is a block diagram of a static-mode instruction simulator according to a preferred embodiment of the invention;

FIG. 5 is a block diagram of a dynamic-mode instruction simulator according to a preferred embodiment of the invention;

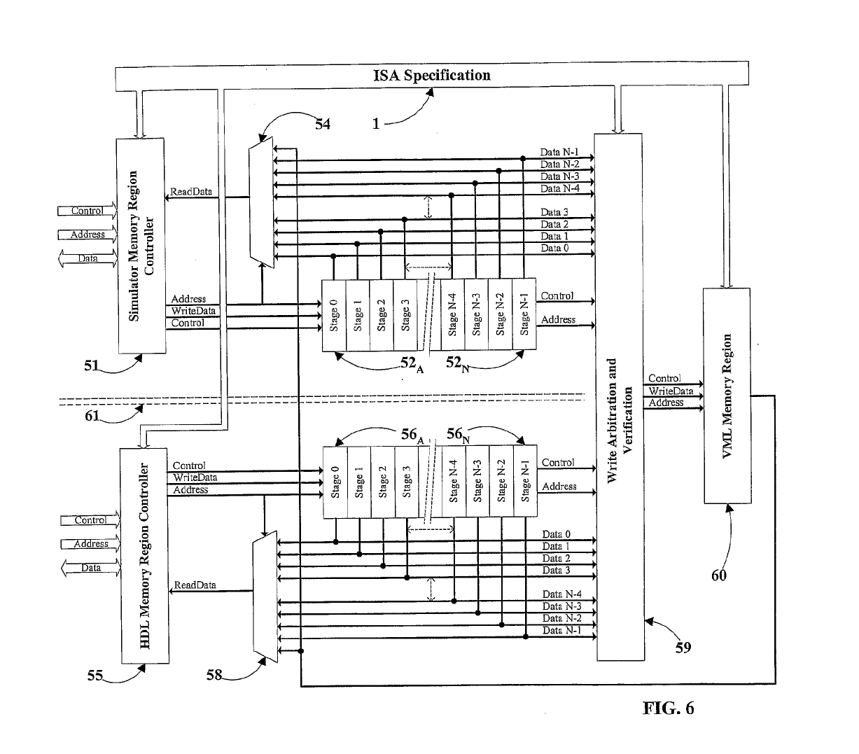

FIG. 6 is a block diagram of the verification method according to a preferred embodiment of the invention;

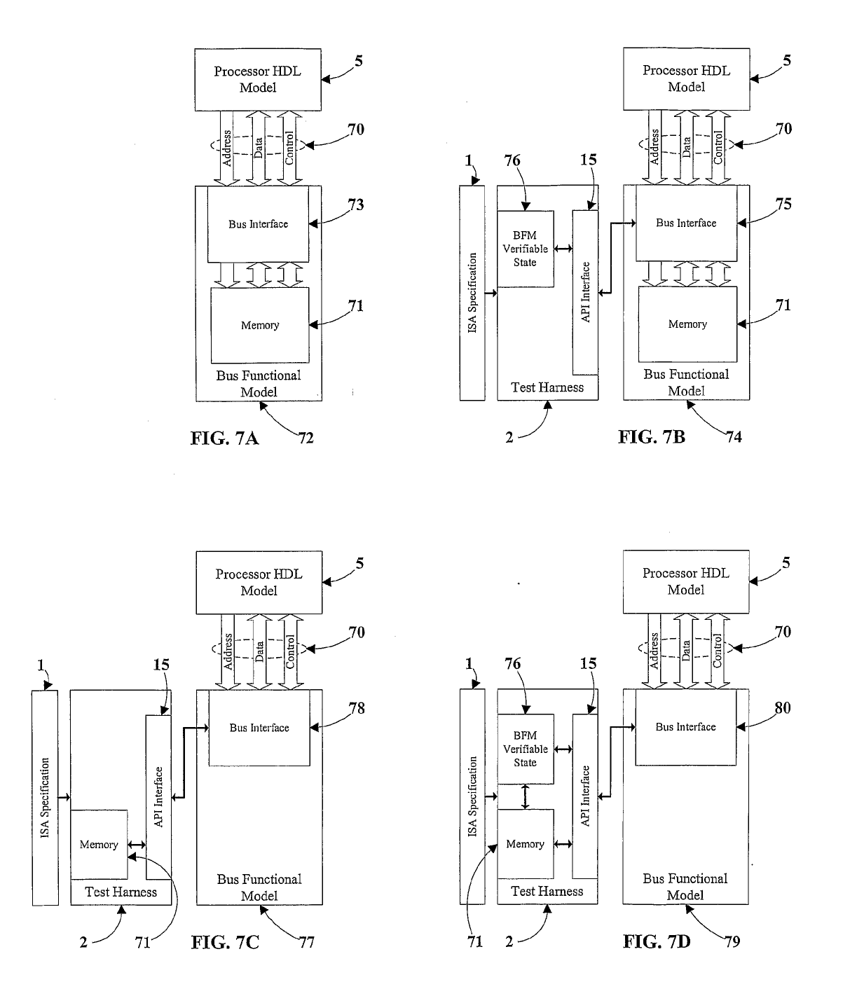

FIGS. 7a-7d are block diagrams of Bus Functional Models which are operative in accordance with various embodiments of the invention;

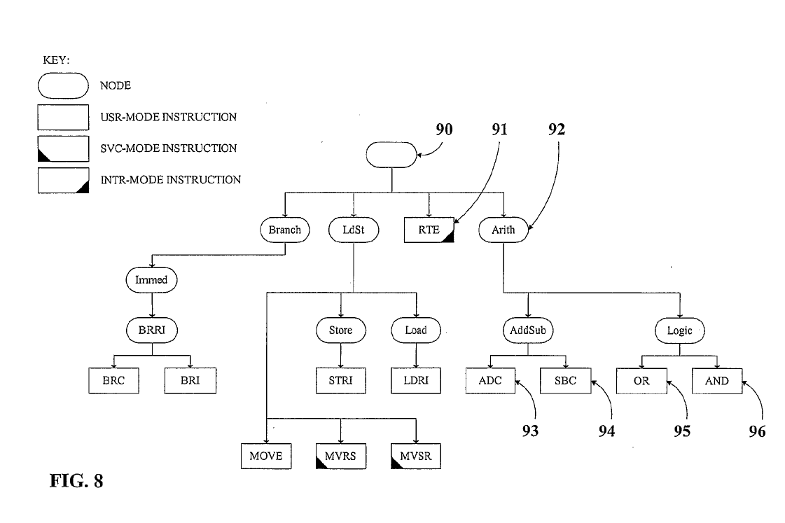

FIG. 8 is an example of an instruction tree derived from an ISA specification;

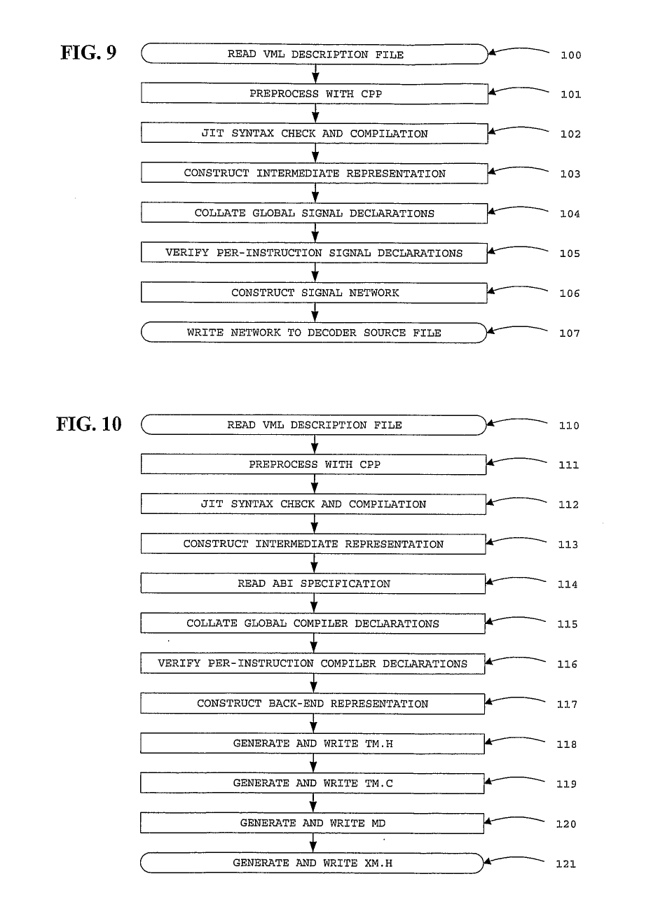

FIG. 9 is a flow chart of a method of HDL decoder generation, which is operative in accordance with a preferred embodiment of the invention;

FIG. 10 is a flow chart of a method for the porting of the GCC compiler by the creation of customized back-end modules, which is operative in accordance with a preferred embodiment of the invention;

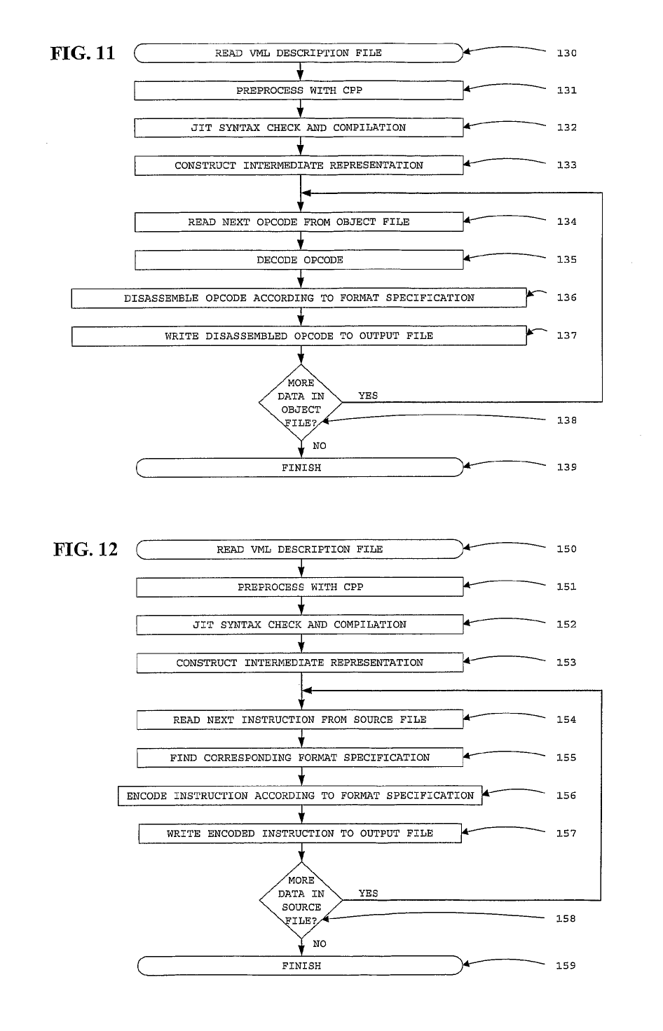

FIG. 11 is a flow chart of a method of disassembler operation, which is operative in accordance with a preferred embodiment of the invention; and

FIG. 12 is a flow chart of a method of assembler operation, which is operative in accordance with a preferred embodiment of the invention.

In the following description, numerous specific details are set forth in order to provide a thorough understanding of the present invention. It will be apparent however, to one skilled in the art, that the present invention may be practiced without these specific details. In other instances the details of computer program instructions for conventional algorithms and processes have not been shown in detail in order not to unnecessarily obscure the present invention.

There is little agreement in the literature of the precise meaning of a number of important terms, including “ISA verification”, “testbench”, and “test harness”. These terms and various dependent terms are therefore defined for the purposes of the present invention in the Glossary provided below at Appendix A.

FIG. 1 shows a schematic depiction of a block diagram of the components of an ISA verification system, that is operable in accordance with a preferred embodiment of the invention.

In one preferred embodiment of the invention, the components to the right of broken line 10 are supplied by the user of the invention, and the components to the left of line 10 comprise the invention. The user of the invention is referred to herein as “the user”.

The user creates an ISA specification 1 for the target processor, which directs the operation of the ISA 10 verification system. ISA Specification 1 is a data file which is stored on a computer-readable medium. In a preferred embodiment, ISA Specification 1 is written in the VML language, which is described below.

The user additionally supplies a processor HDL model 5 for the processor which is to be verified. The processor model may include a decoder 3 which has been created by the present invention. In an alternative embodiment, the processor model may include the user's own implementation of a decoder 3. In order to carry out verification, the user must define a Model State 11 within the processor model. The user defines the Model State 11 in ISA Specification 1, preferably using special VML language constructs for the purpose.

Test harness 2 is described in detail below, and operates according to ISA Specification 1. The test harness executes a test program by simulation, and ensures that the processor model executes the same test program, approximately simultaneously. The test harness determines whether or not the execution of the test program by the processor model is consistent with its own internal simulation of the test program, and it reports its conclusions to the user.

Model state 11 includes some subset of the state of the processor model. The required state is described in detail below, and will normally include Memory 14, Registers 13, and Exceptions 12. ISA Specification 1 should include definitions of Model State 11, in a form which will be described below. The test harness uses ISA specification 1 to create its own version of the state of the processor model; this is Verifiable State 16. Verifiable State 16 will normally include Exceptions 17, Registers 18, Memory 19, and one or more additional Memories 20 and 21.

Memory 14 and Registers 13 represent any non-transient state of the processor model that the user wishes to select for verification. This state might include, for example, any registers or memory within the processor model, or any control outputs from the processor model.

The processor model must notify the test harness when it wishes to change Model State 11. This notification takes the form of a call to API Interface 15 within the test harness. The purpose of a notification is to allow the test harness to update Verifiable State 16. The test harness queues any notifications from the processor model, in a structure known as the “design pipeline”.

The test harness also carries out an instruction-level simulation according to ISA Specification 1; this simulation is referred to herein as “the first simulation”. The first simulation also attempts to update Verifiable State 16, and the test harness queues any update requests from the first simulation in a structure known as the “specification pipeline”. The test harness carries out verification by continuously comparing the design pipeline against the specification pipeline, using a method which is described below. If the two pipelines request a consistent change, then that change is made to Verifiable State 16.

The user further supplies a testbench, comprising Stimulus Generator 4. Stimulus Generator 4 is responsible for providing any external stimulus required by the processor model. The precise stimulus required will depend on the nature of the target processor, but will normally include a periodic Clock 23, and a number of exceptions. The exceptions may include a Reset 24, and one or more interrupts Intrl 25 to IntrN 26. ISA Specification 1 should include definitions of these exceptions, in a form which will be described below.

If Stimulus Generator 4 generates any exception inputs for the processor model, then it must also notify the test harness when it changes the state of any exception inputs, using an appropriate notification. It is an important aspect of the present invention that the test harness requires no knowledge of Clock 23.

If the target processor has external memory interfaces then the testbench further comprises one or more Bus Functional Models 8, 9 (BFMs). The test harness is not explicitly aware of the existence of any BFMs and, for the purpose of the description of the operation of the present invention, BFM State 27 and BFM State 29 may be considered to be part of Model State 11. Memory 28 and Memory 30 must be described in ISA Specification 1 in exactly the same way as Registers 13 or Memory 14, and the test harness creates corresponding memory regions within Verifiable State 16.

The user may direct the test harness to execute an existing test program by supplying the name of that program. Alternatively the user may direct the test harness to dynamically create and execute pseudo-random instructions. This procedure is described below.

It is advantageous that the detailed operation of the processor model is unknown to the test harness. The test harness is therefore re-usable, and it will function correctly with a plurality of different processor models. In particular, the test harness will function correctly even if the processor model employs out-of-order or speculative execution techniques.

It is also advantageous that the test harness requires no knowledge of the external interfaces of the processor model, and that it does not monitor transactions on these interfaces. In order to carry out verification, the test harness requires only the notifications which arrive through API Interface 15.

In an embodiment of the present invention, the ISA verification system runs as a multi-threaded application. Referring to FIG. 3, HDL Simulator 43 comprises two primary threads of execution. The first of these is the thread created by the operating system (the HDL thread) when HDL Simulator 43 starts execution. The Simulator Kernel 41 and Testbench 42 modules are executed in the HDL thread. For simplicity, the HDL thread is referred to herein as a single thread, although it may actually be composed of many related threads of execution.

The second primary thread of execution (the simulator thread) is created by Test Harness 2 when it is initialized by Testbench 42. The Test Harness 2 and Generator Control 6 modules are executed in the simulator thread. The simulator thread also creates a number of additional threads for verification purposes, as is described below.

During the verification process, both the Simulator Kernel 41 and Test Harness 2 will independently carry out simulations of the test program, in their respective threads. The test harness carries out an instruction-level simulation, as defined by ISA Specification 1 (referred to as the first simulation).

Simulator Kernel 41 may carry out a simulation at any level of abstraction as required by the user (referred to as the second simulation), although it will normally be a cycle-accurate simulation of a Register Transfer Level (RTL) model of the target processor.

The supplier of Processor HDL Model 5 will guarantee that their processor model conforms to ISA Specification 1, since that is the purpose of an ISA specification. This is equivalent, when using the method described below, to guaranteeing that the results of the second simulation will agree with the results of the first simulation. The test harness therefore carries out verification by comparing the results of the two simulations, using the knowledge that the first simulation must be correct. If there is an error in Processor HDL Model 5, or Bus Functional Models 8 or 9, the test harness will detect that the two simulations are not equivalent, and will report an error to the user.

The primary complication in this method is that, for all but the simplest target processors, the second simulation may appear to be incorrect when compared to the first simulation, when it is in fact correct. The reason for this is that the supplier of the processor model may not guarantee that their model conforms to ISA specification 1 at all times during execution. This is because many processor models may choose to male their execution conform to ISA Specification 1 only at certain times during the execution of a program. If the state of the second simulation is examined at points other than these times, then it will appear that the program has been executed incorrectly. This is common in many processors, including those that perform speculative or out-of-order execution.

The present invention addresses this problem by defining a verifiable state within the processor model, and within ISA Specification 1. The test harness maintains a copy of the verifiable state, and controls all accesses to it. When the first simulation needs to make a change to the verifiable state, it adds a request to a queue in the simulator thread. Similarly, when the second simulation needs to make a change in the verifiable state, it adds a request to a queue in the HDL thread. The test harness maintains both queues and decides whether they are consistent. If both queues contain a consistent request to update a part of the verifiable state, then the test harness will fulfill that update request. If the test harness detects that the queues are inconsistent, then it will report an error. This method is now described in detail, with reference to FIG. 6.

The verifiable state may be expressed as a plurality of memory resources, and ISA Specification I contains a definition of each such memory resource. The test harness verifies accesses to each of these memory resources using a method executed by a system that is depicted schematically in FIG. 6. The components described in FIG. 6 are referred to herein as a “region state pipeline”. Every verifiable memory resource defined in ISA Specification 1 has its own corresponding region state pipeline. A simple processor might, for example, have only three region state pipelines, including one for a status register, one for a general-purpose register bank, and one for a main memory. The components above broken line 61, with the exception of ISA Specification 1, are referred to herein as the “specification pipeline”. The components below line 61 are referred to herein as the “design pipeline”. Components Write Arbitration and Verification 59, VML Memory Region 60, and ISA Specification 1 are common to both the specification pipeline and the design pipeline.

Simulator Memory Region Controller 51 is referred to herein as the “SMRC”. HDL Memory Region Controller 55 is referred to herein as the “HMRC”. VML Memory Region 60 is referred to herein as the “memory region”.

When the first simulation wishes to update a part of the verifiable state, it first identifies the corresponding region state pipeline. It then issues an update request to the appropriate SMRC. The update request is then pushed onto the “Simulator update queue”, composed of elements Stage 0 through Stage N-1 52_{A-N}. These interconnected elements form a variable-length queue, containing N stages, of uncommitted update requests. The new update request is stored in the highest-numbered stage which does not already contain an update request.

When the second simulation wishes to update a part of the verifiable state, it carries out an identical procedure to the one described above for the first simulation. However, in this procedure the update request is instead issued to the HMRC, rather than the SMRC, and the update request is then pushed onto the “HDL update queue”, which is composed of elements Stage 0 through Stage N-1 56_{A-N}.

Update requests are comprised of write requests, and read requests from ‘volatile’ memory regions. A volatile memory region is one in which a read operation may potentially change some part of the verifiable state. Reads of volatile memory regions are therefore queued and verified in the same way as write requests. The read data must, however, be returned immediately; the read request is therefore queued, together with the data that was actually returned, to allow later verification of the read operation. Examples of volatile memory regions include some FIFOs and I/O ports.

Reads of non-volatile memory regions do not change any part of the verifiable state, and there is therefore no need to queue non-volatile read requests. The requested data is simply returned immediately, using the method described below.

When the first simulation wishes to read a non-volatile memory region, it first identifies the corresponding region state pipeline. It then issues the read request to the SMRC. The SMRC determines whether or not the read request can be satisfied from an existing uncommitted write request in the simulator update queue. If so, it directs multiplexor 54 to select the corresponding uncommitted write data, and it returns this uncommitted write data. If the simulator update queue contains more than one entry which could satisfy the read request, then the SMRC must ensure that the data corresponding to the last issued write request is returned. If the SMRC determines that the read request cannot be satisfied by any entries in the simulator update queue, it instead reads the required data directly from the memory region, and directs multiplexor 54 to return this data.

When the second simulation wishes to read a non-volatile memory region, it carries out an identical procedure to the one described above for the first simulation. However, in this procedure the read request is instead issued to the HMRC, rather than the SMRC, and the HMRC searches the HDL update queue for the required data. The read data is selected by multiplexor 58 rather than multiplexor 54.

The first simulation executes in the simulator thread, and the simulator thread is therefore responsible for writing to the specification pipeline. Similarly, the second simulation executes in the HDL thread, and the HDL thread is therefore responsible for writing to the design pipeline. In a preferred embodiment, a third execution thread (the checker thread) is responsible for reading both the specification pipeline and the design pipeline, for determining whether or not the two pipelines are consistent, and for extracting data from these two pipelines and writing it to the appropriate memory region. In a preferred embodiment, one checker thread exists for each region state pipeline (in other words, one checker thread exists for each verifiable memory region defined in ISA Specification 1).

The checker thread for a region state pipeline is activated whenever new data is written into either the specification pipeline or the design pipeline. When the thread is activated, the Write Arbitration and Verification 59 module (the WAV module) searches both the simulator update queue and the HDL update queue, looking for matching entries.

In a preferred embodiment, the scheduling of the simulator thread, the HDL thread, and any checker threads is controlled by the operating system. The operating system will not normally immediately activate a thread when an activation request is made. The effect of this is that the update queues will normally contain a significant number of entries, and an update queue may fill before a checker thread is activated.

When the checker thread is activated, the WAV module searches both the HDL update queue and the simulator update queue in order to locate corresponding entries in the two queues. These entries are checked for correctness and removed from the queues. The checker thread then suspends until it is again re-activated. This procedure is repeated continuously until the verification process is terminated.

The queue search procedure is now described with reference to the example queues illustrated in Table 1 below, for the case of an 8-stage pipeline. This procedure assumes that the processor to be verified is capable of multiple instruction issue, out-of-order completion, and speculative execution. However, exactly the same procedure may be used to verify much simpler processors which do not have these advanced capabilities. It will be apparent to those skilled in the art that a number of simplifications are possible when verifying less advanced processors, and that these simplifications may be employed to increase the performance of the verification system.

For this example, the memory region contains at least 16 addressable locations; it might be, for example, a 16-entry general purpose register block, addressed as R0 to R15. For simplicity, the queues are assumed to contain only write requests, rather than volatile read requests. However, the procedure for dealing with volatile read requests is essentially identical.

TABLE 1

| Stage index | | | | | | | |
|---|---|---|---|---|---|---|---|
| 0 | 1 | 2 | 3 | 4 | 5 | 6 | 7 |

HDL update queue

| | | | | | | | | |
|---|---|---|---|---|---|---|---|---|
| Address | 15 | 14 | 13 | SYNC | 2 | 4 | 1 | 3 |

Simulator update queue

| | | | | | | |
|---|---|---|---|---|---|---|
| Address | 1 | 8 | 4 | 3 | 2 | 1 |

The WAV module starts searching at the earliest entry in the HDL update queue; this entry is at index 7 and, for this example, has the address value ‘3’. It then searches the Simulator update queue, starting at index 7 and progressing towards index 0, looking for the first entry containing the address ‘3’. This entry is found at index 5. These two entries form a match, and they are checked for correctness, using the procedure described below, before being removed from the queues. The queues are then advanced. After removing the two entries, the queues now contain the following data:

TABLE 2

| Stage index | | | | | | | |
|---|---|---|---|---|---|---|---|
| 0 | 1 | 2 | 3 | 4 | 5 | 6 | 7 |

HDL update queue

| | | | | | | | |
|---|---|---|---|---|---|---|---|
| Address | 15 | 14 | 13 | SYNC | 2 | 4 | 1 |

Simulator update queue

| | | | | | |
|---|---|---|---|---|---|
| Address | 1 | 8 | 4 | 2 | 1 |

This procedure is then repeated to find any subsequent matches. The procedure stops when no more matches can be found, or when index 7 in the HDL update queue contains a ‘SYNC’ entry. The purpose of the SYNC entry is described in detail below.

For this example, the WAV module finds three more matching entries, for addresses ‘1’, ‘4’, and ‘2’. The search procedure now stops, because index 7 in the HDL update queue contains a ‘SYNC’ entry. At this stage, the queues now look as follows:

TABLE 3

| Stage index | | | | | | | |
|---|---|---|---|---|---|---|---|
| 0 | 1 | 2 | 3 | 4 | 5 | 6 | 7 |

HDL update queue

| | | | | |
|---|---|---|---|---|
| Address | 15 | 14 | 13 | SYNC |

Simulator update queue

| | | |
|---|---|---|
| Address | 1 | 8 |

The checker thread now suspends, and waits until it is re-activated, when more data has been written into the queues.

A match occurs when the WAV module finds two entries which both request a write to the same address within the memory region. If the simulator and the HDL entries contain identical data, then the processor model has correctly requested a state change, and both entries are deleted from their respective queues. The write is now committed to memory with the data being written to the required address within VML Memory Region 60. If the two entries contain different data then, in one embodiment of the invention, an error is deemed to have occurred. This is a Mode 4 error, as defined below. This error is recorded in a log file, and the two write entries are deleted from their respective queues.

In a further embodiment of the invention, a slightly different checking procedure is required. This embodiment is required for processor models which may speculatively change state incorrectly, and then correct that state at some later time.

In this embodiment, the WAV module does not carry out correctness checking until some defined point after the last time at which the processor model has queued a state update for a particular address. Checking always occurs when a SYNC point is reached in the HDL update queue. Otherwise, the ‘defined point’ may be reached either when a configurable fixed time delay has elapsed, or when the processor model has subsequently made a configurable number of state changes to other memory regions, or to other addresses within this memory region. When this defined point has been reached, the WAV module tests the last data written by the processor model against the data required by the first simulation. If the data is incorrect, then a Mode 4 error, as defined below, has occurred. All the entries involved in this check are then removed from the update queues.

If the processor model has correctly requested a state change, the WAV module will write the requested data into the memory region. If the processor model has made an incorrect request, then the WAV module will instead write the correct data, as determined by the first simulation, into the memory region. This procedure ensures that the verifiable state of the test harness (Verifiable State 16 of FIG. 1) always contains the current correct view of the simulation.

When the ISA specification of this memory region contains a ‘shared’ attribute, VML Memory Region 60 also implements the memory required by the processor model. This has no effect on the operation of the verification process.

If the processor model or any of the BFMs are functioning incorrectly, then a number of error conditions may occur:
Mode 1 error: The HDL thread does not add an update entry to any design pipeline; for example, the processor model may omit a flag update for an instruction which should set that flag.
Mode 2 error: The HDL thread adds an update entry to an incorrect design pipeline; for example, the processor model may attempt to write to an address register, when it should have written to a data register.
Mode 3 error: The HDL thread adds an update entry to the correct design pipeline, but with an incorrect address; for example, the processor model may incorrectly calculate a register address and attempt to write to that register.
Mode 4 error: The HDL thread adds a write entry to the correct design pipeline, with a correct address, but with incorrect data; for example, the processor model may incorrectly calculate the result of an arithmetic operation.

The verification procedure for volatile reads is identical to the write case described above, except that no data is written to memory. The mode 1, mode 2, and mode 3 errors are defined identically. A mode 4 error occurs if the two read entries in the simulator and the HDL update queues returned different data.

Mode 4 errors are detected directly during the WAV module search procedure described above. The remaining errors will result in unmatched entries in either the specification or the design pipelines, which may eventually lead to a pipeline overflow. The pipelines should all be empty at the end of simulation, so these errors can easily be detected when simulation has completed. However, it will normally be necessary to detect these errors soon after they occur, in order to simplify the debugging of the processor model or the BFMs. In order to detect these errors promptly, all updates to the specification and the design pipelines are given a sequence number. This sequence number is stored as part of the entry in the update queues. Detecting an error is now a simple matter of comparing the sequence number of any unmatched entries in an update queue with the sequence number of the next unmatched entry in that queue, or in any other queue. If the difference in the sequence numbers exceeds a preset threshold, then an error is deemed to have occurred. This error is recorded in a log file, and the erroneous entry is deleted from its queue. This procedure is described in detail below.

When a single error is detected in a pipeline, it is a simple matter to detect and remove that error and to carry on verification. However, in practice, it is likely that the HDL model will make a number of errors before resuming correct execution. To be of maximum use, the verification environment should attempt to ‘resynchronize’ the two simulations when multiple errors occur, so that verification can continue. Resynchronization is analogous to the general problem of comparing two binary files, and finding the first matching region after detecting a difference region. In a preferred embodiment, the present invention uses a ‘sliding window’ mechanism to attempt Resynchronization. In this mechanism, the two queues are examined using a small window of a configurable size (which will generally be in the region of 3 queue entries). The two windows are initially placed immediately after the detected error, and the contents of the two windows are compared. If the queue entries covered by the two windows cannot be reconciled, then the windows are progressively moved through the remainder of the queues. If the queues cannot be reconciled, and no more data can be entered into the queues, then the error is reported and verification is terminated. However, if the contents of the two windows can be reconciled, then all entries up to the window locations are flushed, the error is reported, and verification continues normally.

As a simple example of the use of sequence numbers, consider a processor whose verifiable state includes only a set of data registers, a Status register, and an external memory. This gives a total of 3 memory regions, within 3 region state pipelines. The RTL implementation of the processor model includes out-of-order execution, but it is known that there are never more than two outstanding write operations which have not completed. Consider also that this processor is executing the code sequence in Listing 1:

Listing 1

| | | |
|---|---|---|
| MUL | R1,R7,R8 | // R1 [symbol] R7*R8 |
| LD | R2, (R9) | // R2 [symbol] (R9) |
| ADD | R3,R9,R10 | // R3 [symbol] R9+R10 |
| ADD | R4,R9,R1 | // R4 [symbol] R9+R1 |

The processor model issues the first 3 instructions on cycle N, and issues the fourth instruction on cycle N+1. However, an error in the HDL code means that the processor will write the result of the third instruction to R5, rather than R3 (a Mode 3 error). The processor is capable of out-of-order completion and, because of the differing latencies of the function units involved, it schedules the completion of instruction 1 for cycle N+4, instruction 2 for cycle N+3, instruction 3 for cycle N+2, and instruction 4 for cycle N+6. This is summarized in Table 4 below, which shows the HDL and simulator update queues for the ‘register’ memory region.

TABLE 4

Stage index

| | | | |
|---|---|---|---|
| 4 | 5 | 6 | 7 |

HDL update queue

| | | | | |
|---|---|---|---|---|
| Sequence number | x + 3 | x + 2 | x + 1 | x |
| Address | 4 | 1 | 2 | 5 |

Simulator update queue

| | | | | |
|---|---|---|---|---|
| Sequence number | y + 3 | y + 2 | y + 1 | y |
| Address | 4 | 3 | 2 | 1 |

It should be noted in Table 4 that the simulator update queue represents a strictly in-order view of instruction execution, and that R1 is scheduled to be written first, and R4 last. The HDL update queue represents the out-of-order write sequence used by the processor model. It should also be noted that this is only one possible view of the ‘register’ update queues following the execution of the instruction sequence of Listing 1. In practice, the ‘register’ memory region checker thread may activate before the update queues contain all the entries depicted in the table, so the queues may never fill to the point shown. However, this does not affect the verification procedure.

At some point, the ‘register’ memory region checker thread will be activated, and it will determine that there are consistent writes to R2 and R1. These writes will then be committed to VML Memory Region 60, and will be removed from the queues. The update queues for the ‘register’ memory region will then appear as shown in Table 5 below.

TABLE 5

Stage index

| | | | |
|---|---|---|---|
| 4 | 5 | 6 | 7 |

HDL update queue

| | | |
|---|---|---|
| Sequence number | x + 3 | x |
| Address | 4 | 5 |

Simulator update queue

| | | |
|---|---|---|
| Sequence number | y + 3 | y + 2 |
| Address | 4 | 3 |

The checker thread now determines that the write to R4 can be committed to memory. However, the R4 write has an HDL sequence number of ‘x+3’, and there is a prior uncommitted entry in the HDL update queue which has the sequence number ‘x’. For this processor, it is known that there are never more than two outstanding write operations which have not completed. The HDL write with sequence number ‘x’ must therefore be in error, since the updates with sequence numbers ‘x+1’ and ‘x+2’ have already completed. The test harness records this error in the log file, and removes the erroneous entry from the HDL update queue. A similar method is used to remove the R3 entry from the Simulator update queue. Mode 1 and Mode 2 errors are dealt with in the same way; the only difference is that Mode 1 and Mode 2 errors require data to be removed from only one queue, whereas a Mode 3 error requires data to be removed from both queues.

In the preferred embodiment, the simulator and the HDL update queues within a region state pipeline have a fixed maximum size which can be set by configuration, or according to the ISA specification. This size is chosen to be large enough to ensure that no queues overflow if the processor model is functioning correctly. The required size will depend on whether or not the processor model can execute speculative or out-of-order writes to this memory region, and on whether or not the VML action specification of any instructions or exceptions carry out multiple writes to a memory region which are later collated into a single write operation. The size of the queues also determines how tightly coupled the first and the second simulations are, since the queues provide the ‘throttling’ control between the two simulations.

When the processor model encounters a serializing exception condition, it will carry on execution until it reaches a serialization point. The processor model then informs the test harness that it has completed serialization and is ready to start execution of the exception, by issuing a notification to the API interface of the test harness. The effect of this notification is to enter a SYNC entry into the design pipeline. In the example of Table 1 above, the processor model has entered a SYNC entry on the HDL update queue at index 3. The processor model then responds to the exception condition. For this example, the exception response results in the processor model adding state update requests for addresses 13, 14, and 15.

The WAV module then searches and analyses both queues using the procedure described above, until the SYNC entry progresses to the head of the HDL update queue, as shown in Table 3 above. Any remaining entries in the Simulator update queue are now known to be incorrect, since they were produced by the first simulation without any knowledge of the exception condition. The test harness therefore removes all the remaining entries in the Simulator update queue, and instructs the first simulation to execute the required exception code, using the procedure described below. The test harness now removes the SYNC entry from the HDL update queue, and verification proceeds as described above.

ISA Specification 1 contains a description of the possible exception conditions, including a set of actions that will be taken when the exception is encountered, and a “handle” that the processor model may use to identify each such exception to API Interface 15. When the processor model receives an exception and reaches a serialization point, it issues a notification to API Interface 15. This notification includes the exception handle, and the handle is subsequently entered into the SYNC entry in the HDL update queue. When the SYNC entry in the HDL update queue has advanced to the head of the queue (Stage N-1 56_{N}), the WAV module flushes all remaining entries in the simulator update queue, and then uses the handle to identify the required exception in ISA Specification 1, and to direct the first simulation to execute the action code for that exception.

If the target processor has external memory interfaces then the user's testbench will include at least one Bus Functional Model (BFM). Each BFM is responsible for responding to low-level accesses on the external ports of the processor model, and therefore implements the functionality required by the memory interface. FIG. 7a shows a schematic depiction of a BFM. Bus Functional Model 72 communicates with Processor HDL Model 5 through Interface Ports 70, which will normally include address, data, and control information. Bus Interface 73 responds to the control and address information on Interface Ports 70, and either writes the requested data to Memory 71, or returns the requested data from Memory 71.

Memory 71 may be provided by the user for the BFM, or it may alternatively be supplied by the invention. In either case, the user may also optionally request that accesses to Memory 71 should be verified by the invention. The combination of these two factors gives a total of four possible implementations of the BFM, which are referred to herein as BFM/0, BFM/1, BFM/2, and BFM/3. FIG. 7a is a block diagram of BFM/0, in which Memory 71 is provided by the user, and is not verified.

Reference is now made to FIG. 7b, which shows a schematic depiction of BFM/1, in which Memory 71 is provided by the user, and accesses to Memory 71 are verified by the invention. The invention maintains a BFM Verifiable State 76 in Test Harness 2, as a part of the total verifiable state of the test harness. Bus Interface 75 must inform Test Harness 2 of any write operations, and any read operations which are to be verified, by supplying an appropriate notification to API Interface 15.

Reference is now made to FIG. 7c, which shows a schematic depiction of BFM/2, in which Memory 71 is provided by the invention, and accesses to Memory 71 are not verified. Bus Interface 78 must inform Test Harness 2 of any read or write operations, by supplying appropriate notifications to API Interface 15.

Reference is now made to FIG. 7d, which shows a schematic depiction of BFM/3, in which Memory 71 is provided by the invention, and accesses to Memory 71 are verified by the invention. The invention maintains a BFM Verifiable State 76 in Test Harness 2, as a part of the total verifiable state of the test harness. Bus Interface 80 must inform Test Harness 2 of any read or write operations, by supplying appropriate notifications to API Interface 15.

The present invention is not concerned with a BFM of type BFM/0. For the three remaining cases, the required functionality of Test Harness 2 must be described in ISA Specification 1, by specifying some combination of the ‘shared’ and ‘checked’ attributes in the memory region declaration. An example of the use of these attributes is given in Listing 14 and Listing 15. If a memory region declaration includes a ‘shared’ attribute, then Test Harness 2 will create an internal Memory 71. If a memory region declaration includes a ‘checked’ attribute, then Test Harness 2 will verify accesses to Memory 71. Memory regions of types BFM/1, BFM/2, and BFM/3 should therefore specify attributes of “checked”, “shared”, and “checked, shared” respectively.

A memory region declaration may include a number of other attributes, in addition to the ‘shared’ and ‘checked’ attributes. These attributes, and their meanings, are listed in Table 6 below.

TABLE 6

| Attribute | Meaning |
|---|---|
| shared | The memory required by the HDL model is implemented |
| | within the test harness |
| checked | HDL accesses to the memory will be verified |
| volatile | A read of a volatile memory changes its state. A volatile |
| | memory might be, for example, a FIFO or an I/O register. |
| | If the ‘checked’ attribute is also specified, read |
| | operations will be verified. |
| unordered N | HDL writes to this region may be unordered. The ‘N’ |
| | parameter is required and specifies the maximum |
| | number of outstanding writes allowed. For the |
| | example processor which executes the code of Listing |
| | 1, this value would be ‘2’. |

The present invention makes no distinction between memory which is internal to the processor model, and memory which is external to the processor model. With reference to FIG. 1, the present invention does not specifically verify Processor HDL Model 5; it verifies the combination of Processor HDL Model 5, and any Bus Functional Model(s) 8 and 9. ISA Specification 1 and Test Harness 2 do not distinguish between ‘internal’ and ‘external’ memory; this means that Registers 18, Memory 19, Memory 20, and Memory 21 are all equivalent parts of Verifiable State 16.

A consequence of this is that the BFM implementation description above is equally applicable to internal memory within the processor model. Internal memory within the processor model might include, for example, single registers, register banks, or control outputs. These internal memory regions are defined in ISA Specification 1 in exactly the same way as the memory required by a BFM, and the HDL designer uses the same notifications for both ‘internal’ and ‘external’ memory implementation and verification purposes.

Reference is now made to FIG. 1, in order to better understand the use of the API Interface. The user of the invention communicates with the test harness through API Interface 15, by calling routines within the API Interface (these calls are referred to as notifications). These notifications may be made from various parts of the user's code, including Processor HDL Model 5, Stimulus Generator 4, and any Bus Functional Models 8 and 9. These notifications have a number of purposes, which are summarized in Table 7 below. The ‘Notified from’ column in this table gives the number of the module in FIG. 1 which will normally be responsible for issuing this notification. In practice, the user may issue these notifications from any desired point in their code.

TABLE 7

| | Notified |
|---|---|
| Purpose of notification | from |
| Initialising the test harness, starting the first simulation, and | 4 |
| stopping the test harness | |
| Writing or reading a memory which has the ‘shared’ attribute | 5, 8, 9 |
| Verifying a write to or a read from a memory which has the | 5, 8, 9 |
| ‘checked’attribute | |
| Informing the test harness when an exception is applied to the | 4 |
| processor model | |
| Informing the test harness when the processor model has | 5 |
| serialised execution and is ready to start processing an exception | |
| Retrieving Verifiable State 16, for the purposes of reactive | 6 |
| instruction generation | |
| Setting generator constraints for Instruction Generator 22 | 6 |
| Various miscellaneous purposes, including the control of log | 4 |
| file and trace file generation, coverage configuration, the | |
| addition of user messages to the log file, and the addition | |
| of the contents of specific memory locations to the | |
| trace file | |

The API interface may be implemented in a number of languages, and consists of a large number of detailed notifications. The API Interface has therefore not been shown in detail here in order not to unnecessarily obscure the present invention. A small number of representative notifications are shown here, and are presented as C++ prototypes in Listing 2 below.

Listing 2

| | |
|---|---|
| uint64_t | VML_word_read(int handle, uint64_t address, int |
| | *errcode); |
| void | VML_word_read_verify(int handle, uint64_t address, |
| | uint64_t rdata, int *errcode); |
| void | VML_word_write(int handle, uint64_t address, uint64_t |
| | wdata, uint64_t wmask, int *errcode, bool bypass); |
| void | VML_exception_raise (int handle); |
| void | VML_exception_commit(int handle); |

In this embodiment, the ‘uint64_t’ type is a 64-bit integer, and this type is used exclusively by the user's HDL code when referring to addresses or data in the notifications. If the HDL code implements address or data quantities which are smaller than 64 bits, then these quantities are stored at the bottom of a 64-bit word.

The read and write notifications identify a memory region within the ISA specification using an integer ‘handle’. An example of a memory region declaration is given in Listing 14, which defines a status register, with a handle of HANDLE_STATUS. In this example, HANDLE_STATUS is a macro, and its integer value is supplied by the preprocessor. If the memory region has a ‘shared’ attribute, then ‘VML_word_read’ and ‘VML_word_write’ carry out word read and write operations, respectively, within the memory in the test harness. If the memory region has a ‘checked’ attribute, then ‘VML_word_write’ also verifies this write operation. ‘VML_word_read_verify’ may be used to verify read operations. These routines have an optional ‘errcode’ parameter, which is used by the routine to return an error code to the caller. The write routine also has an optional ‘wmask’ parameter, which defines a bit mask for the write operation. The write routine also has an optional ‘bypass’ parameter. This parameter may be used to bypass the verification procedure for an individual write operation to a ‘checked’ memory region.

There are equivalent ‘byte read’ and ‘byte write’ notifications for memory regions which are defined as being byte-addressable using the ‘byte address’ attribute.

The ‘VML_exception_raise’ and ‘VML_exception_commit’ notifications identify an exception within the ISA specification using an integer handle. An example of a exception declaration is given in Listing 17, which defines an interrupt, with a handle of HANDLE_INTR2, where the integer value of HANDLE_INTR2 is again supplied by the preprocessor. Stimulus Generator 4 calls ‘VML_exception_raise’ when it applies an exception to the processor model. If the processor model decides to respond to an exception, it should call ‘VML_exception_commit’ after serializing execution, and before starting the exception response.

Simulations may be run in either a “static” mode, or a “dynamic” mode. Reference is now made to FIGS. 2 to 5 to describe these two modes.

FIG. 2 is a block diagram of the components of an HDL simulator when run in the static mode of operation, and FIG. 4 is a block diagram of the components of an Instruction Simulator when run in the static mode of operation. In static mode, an existing Test Program 7 is read and executed by Test Harness 2. Test Program 7 is created before simulation commences, and may be the output of an assembler, compiler, or similar tool. Test Program 7 may also have been created by a previous dynamic-mode simulation.

FIG. 3 is a block diagram of the components of an HDL simulator when run in the dynamic mode of operation, and FIG. 5 is a block diagram of the components of an Instruction simulator when run in the dynamic mode of operation. In dynamic mode, a test program is created during execution. The test program is created by Test Harness 2, in conjunction with the user-supplied Generator Control 6. This procedure is described below. The ‘dynamic’ test program which is created during simulation may be saved on computer-readable media, which will allow it to be used as Test Program 7 during subsequent static-mode simulations. In dynamic mode, the test program may be created in response to the current state of the first simulation; this is possible because Generator Control 6 can determine the current state of the simulation through the API interface of the Test Harness. A test program which is created in this fashion is known as a ‘dynamic reactive’ test program. This procedure allows a high degree of flexibility which is essential for some test operations.

In a preferred embodiment of HDL Simulator 43 and Instruction Simulator 47, Generator Control 6 is a user-supplied software component which must be compiled by the user and linked together with various other modules in order to create the required simulator. Alternative embodiments exist in which it is not necessary for the user to compile and link Generator Control 6. In one such embodiment, Generator Control 6 is implemented as a data file which is stored on computer-readable media. A dynamic-mode simulator would then read and act on Generator Control 6 during the course of simulation.

In a preferred embodiment, the Test Harness may be a computer software product which exists as a library module. The Test Harness must therefore be linked with other computer software products before it can be used for verification. This procedure is now described with reference to FIG. 2 and FIG. 3.

The Test Harness 2 may be a single software component of a complete program which carries out an HDL simulation. This program is HDL Simulator 40, or HDL Simulator 43. HDL Simulators 40 and 43 comprise the Test Harness 2, Simulator Kernel 41, and Testbench 42 components. When carrying out a dynamic-mode simulation, HDL Simulator 43 further comprises of Generator Control 6.

The Simulator Kernel 41 may be provided by a simulator vendor. There are many simulator vendors; one example is Synopsys Inc., which provides simulator kernels for the Verilog, VHDL, and SystemC languages. In an alternative embodiment, Test Harness 2 itself comprises Simulator Kernel 41. Generator Control 6 and Testbench 42 are provided by the user of the invention.

In order to create HDL Simulators 40 and 43, the user must first compile Testbench 42 and, for a dynamic-mode simulation, Generator Control 6. These modules must then be linked with Test Harness 2 and Simulator Kernel 41 into an executable program. The specific steps required to carry out this procedure will depend on a number of factors, but will be well known to anyone skilled in the art. Listing 3 below shows parts of a Testbench 42, for the case in which Testbench 42 is written in C++, and Simulator Kernel 41 is the OSCI SystemC simulator. Listing 4 below shows the corresponding makefile, which directs the creation of an executable program. The program created by this makefile is called ‘hdlsim’, which is HDL Simulator 40.

int sc_main(int argc, char* argv[ ]) }

| // initialise the VML test harness | |
|---|---|
| VmlSimParams vsp; | |
| vsp.stf | = get_sim_time; |
| vsp.scf | = generate_scenario; |
| vsp.stop | = stop_sim; |

| VML_sim_init(vsp, argc, argv); | |
|---|---|
| // add any VML traces, set the time resolution | |
| VML_register_trace(VmlTrace(“R”, 45, 0)); | // trace R[0] |
| sc_set_time_resolution(100, SC_PS); | |

| // declare top-level signals and instantiate the core | |
|---|---|
| SigBool Clk; | |
| . . . | // lots more signals |
| ProcCore core (“ProcessorCore”); | |
| core.Clk (Clk); | // connect the core's ports |
| . . . | // lots more connections |
| // instantiate the L1 memory system, connect its ports | |
| bfm memory (“L1_memory”, HANDLE_MEMORY); | |
| memory.Clk (Clk);// connect the BFM's ports | |
| . . . | // lots more connections |
| // instantiate the test harness, connect its ports | |
| test_harness TestHarness(“VX_Harness”); | |
| TestHarness.Clk (Clk); | |
| . . . | // lots more connections |

| // start the simulation | |
|---|---|
| VML_sim_start( ); | |
| sc_start( ); | // run until ‘sc stop’ called |
| VML_sim_stop( ); | // shut down simulator threads |
| return (0); | |

}

Listing 3

| | |
|---|---|
| LIBS = | -lsystemc -lproc_model -lm -lvml -lgen -lsim \ |
| | -lpthread |
| .cc.o: | |

$(CC) $(CFLAGS) -c $< -o obj/$@

| | |
|---|---|
| BASE_SRC | = proc_tbench proc_stim proc_bfm |
| OBJS | := $(addsuffix .o, $(BASE_SRC)) |
| OBJOBJS | := $(addprefix obj/, $(OBJS)) |
| hdlsim : | $(OBJS) libproc_model.a libvml.a libgen.a libsim.a |

$(CC) -o $@ $(OBJOBJS) $(LIBS) 2>&1 | c++filt

Listing 4

ISA Specification 1 and Test Program 7 are data files which are stored on computer-readable media. At the start of simulation, HDL Simulators 40 or 43 will read ISA Specification 1. Test Harness 2 uses the contents of ISA Specification 1 to configure itself to the requirements of the target processor. When carrying out a static-mode simulation HDL Simulator 40 will read Test Program 7 during the course of the simulation.

In one embodiment of the present invention, the test harness is not used for ISA verification, but is instead used to create an instruction-level simulator. This procedure is now described with reference to FIG. 4 and FIG. 5.

FIG. 4 is a block diagram of the components of a static-mode instruction simulator. Instruction Simulator 45 is composed of Test Harness 2 and Main 44, and does not require any additional user-supplied components. In a preferred embodiment, Instruction Simulator 45 is therefore supplied as a complete stand-alone program. During operation, Instruction Simulator 45 reads ISA Specification 1 and Test Program 7, and carries out a simulation of Test Program 7 according to the requirements of ISA Specification 1. The results of the simulation are presented in the normal way, using a GUI interface or listing files.

FIG. 5 is a block diagram of the components of a dynamic-mode instruction simulator. Instruction Simulator 47 is composed of Test Harness 2, Main 46, and the user-supplied Generator Control 6. In a preferred embodiment, the user creates Instruction Simulator 47 by compiling Generator Control 6, and then linking together modules 6, 46, and 2. The specific steps required to carry out this procedure will depend on a number of factors, but will be well known to anyone skilled in the art.

The present invention includes an instruction generator, which may be used to create an instruction for the target processor. These instructions may be combined by the user in order to create complete test programs for the target processor.

Instruction generation is automatic, and is carried out according to the ISA Specification of the target processor, and according to constraints provided by the user. These constraints may be used to select an instruction either randomly from the instruction set, or some subset of that instruction set, or according to some declared property of that instruction set. The constraints may also be used to select the values of any bit fields which are declared within an instruction.

In a preferred embodiment, the ISA Specification is written in the VML language. The resulting ISA specification is referred to herein as the “VML description”. In order to generate constrained instructions, the instruction generator requires information from a number of different parts of the VML description. The required information from the VML description is now described, with reference to the example ADC instruction which is declared in Listing 18.
1 All generatable instructions must be given a hierarchical name in their opcode declaration. For the ADC instruction, this name is “Arith.AddSub.ADC”. Instructions do not need to be named, but an unnamed instruction cannot be generated.
2 Instructions should contain a declaration of any bit fields which are to be generated. For the ADC instruction, these bit fields are the Rd, Ra, and Rb fields, which encode the destination register and the two source registers, respectively, for the ADC instruction.
3 Instructions may optionally contain a property specification, for a property which has already been declared in a property section. Listing 13 is an example property section, which declares the predefined ‘length’ property, and the user-defined ‘mode’ property. The ADC instruction declares that it has a length of 16 bits, and does not specify what ‘mode’ it has. The ADC instruction therefore has the default mode of USR.
4 The instruction generator requires information about an instruction's encoding when creating that instruction. This information is found in the ‘decode include’ specification.
5 When generating a value for a field, the instruction generator needs to know if any values for that field are disallowed. For the ADC instruction, the ‘decode exclude’ specification states that ‘Rd’ must not be equal to 0.
6 As well as creating an encoded instruction, the instruction generator also creates a disassembled version of the instruction, as a string. The information required to do this is found in the instruction's format specification.

The hierarchical name given in an opcode declaration represents a logical view of a ‘tree’ of instruction functionality. During compilation of the VML description, the compiler creates a hierarchical tree of these instruction names. This tree, together with any declared instruction properties, forms the basis of the instruction selection procedure which is used by the instruction generator, and which is described below.

By way of example, Listing 5 below is part of a VML description for a simple processor, and is used to illustrate the selection procedure. The opcode descriptions contain only field and property specifications, for simplicity. The VML description of this processor also includes Listing 13, which declares this ISA's properties.

Listing 5

| /* Return From Exception; may only be executed in interrupt | |
|---|---|
| * mode */ | |
| opcode RTE { | |
| property mode INTR; | |
| } | |
| // register indirect branch, unconditional | |
| opcode Branch.Immed.BRRI.BRI { | |
| field Ra(6:8); | // load Ra to the PC |
| } | |
| // register indirect branch if CC set | |
| opcode Branch.Immed.BRRI.BRC { | |
| field Ra(6:8); | |
| } | |
| opcode LdSt.MVRS { | // move Rs to the Status register |
| property mode SVC; | // may only be executed in SVC mode |
| field Rs(14:16); | |
| } | |
| opcode LdSt.MVSR { | // move the Status register to Rd |
| property mode SVC; | // may only be executed in SVC mode |
| field Rd(14:16); | |
| } | |
| opcode LdSt.MOVE { | // move Rs to Rd |
| field { | |
| Rd(11:13); | |
| Rs(14:16); | |
| } | |
| } | |

| opcode LdSt.Load.LDRI { | // load (Ra) to Rd |
|---|---|
| field { | |
| Rd(11:13); | |
| Ra(14:16); | |
| } | |
| } | |
| opcode LdSt.Store.STRI { | // store Ra to (Rd) |
| field { | |
| Rd(11:13); | |
| Ra(14:16); | |
| } | |
| } | |
| opcode Arith.AddSub.ADC { | // Rd [symbol] Ra + Rb |
| field { Rd( 8:10); Ra(11:13); Rb(14:16); } | |
| } | |
| opcode Arith.AddSub.SBC { | // Rd [symbol] Ra − Rb |
| field { Rd( 8:10); Ra(11:13); Rb(14:16); } | |
| } | |
| opcode Arith.Logic.OR { | // Rd [symbol] Ra \| Rb |
| field { Rd( 8:10); Ra(11:13); Rb(14:16); } | |
| } | |
| opcode Arith.Logic.AND { | // Rd [symbol] Ra & Rb |

field { Rd( 8:10); Ra(11:13); Rb(14:16); }
}

FIG. 8 gives the corresponding tree view of this instruction set. The tree is rooted at 90. Any instructions named in the VML description appear as leaves in this tree. These leaves appear in rectangular boxes; an example of a leaf is RTE 91. The tree also contains nodes, which contain all leaves descended from that node. The nodes appear in rounded boxes; an example of a node is Arith 92. Node Arith 92 contains leaves ADC 93, SBC 94, OR 95, and AND 96. Listing 5 and the corresponding name tree of FIG. 8 define a total of 12 instructions for the target processor.

The instruction generator also classifies instructions according to any properties that an instruction has. The instructions of Listing 5 have two properties which may be used to constrain instruction generation; these are the ‘length’ and ‘mode’ properties. Three of the instructions of Listing 5 are given a non-default ‘mode’ property, and these instructions are correspondingly marked in FIG. 8.

The instruction generator uses two basic mechanisms to select an instruction for generation, under the control of the user's constraints. Instructions may be selected according to the name of a leaf or node in the name tree, and instructions may be selected according to a property of that instruction. These mechanisms may be combined arbitrarily in order to select an instruction. As an example, the user may specify constraints which request that a ‘LdSt’ instruction should be generated, which also has a mode of SVC, and a length of less than 24 bits.

When generating an instruction, the generator first solves any generation constraints which have been placed on that instruction. There are three potential outcomes to the constraint solution process, which are described below with reference to the example instruction set of Listing 5 and FIG. 8.
1 There are no possible solutions which satisfy all constraints. This would occur, for example, if the user has requested an ‘Arith’ instruction which has a mode of SVC, since there are no such instructions. This outcome is referred to herein as a ‘contradiction error’. In this case, the generator reports that an error has occurred, and returns a default instruction.
2 There is exactly one solution; in this case, the generator returns that solution.
3 There is more than one solution. In this case, the default action of the generator is to randomly select one of the potential solutions, giving all potential solutions an equal weighting, and to return the selected solution. As an example, if the user requests an ‘AddSub’ instruction, the generator will return ADC 93 with a probability of 0.5, or SBC 94, with a probability of 0.5. The user may alternatively specify the required generation probabilities by using a ‘Select’ constraint.

When no constraints are specified for an instruction, the generator will return any instruction from the instruction set, with each being given an equal probability.

When attempting to solve a set of constraints, the generator distinguishes between two different classes of constraint. The ‘Keep’, ‘KeepIn’, and ‘KeepOut’ constraints are referred to herein as ‘hard’ constraints. The ‘Select’ constraint is referred to herein as a ‘soft’ constraint. The generator first attempts to satisfy all the hard constraints which have been applied to a generatable item. If it is not possible to satisfy all such constraints simultaneously, the generator will report a contradiction error, and the generation process has failed. If the hard constraints can be solved, or if there are no hard constraints, the generator will then attempt to satisfy any soft constraints, by selecting from any instructions or integer values which remain after applying the hard constraints. It is not an error condition if the soft constraints can not be solved.

The use of the Instruction Generator is described with reference to FIG. 1. Instruction Generator 22 is accessed by the user through API interface 15. In order to use the Instruction Generator, the user must write code that declares instructions and their constraints, and which initiates generation of those instructions. This user-provided code is Generator Control 6. The user may write Generator Control 6 in any one of a number of languages, and the precise procedure used will depend on the language selected. In one embodiment, API Interface 15 and Generator Control 6 are both written in the C++ language. The listings presented here are written in C++ to illustrate this embodiment.

From the user's point of view, an ‘instruction’ is an object of the VmlInstruction class. A VmlInstruction object has a number of public fields, which include:

| | | |
|---|---|---|
| int | len; | // opcode length, in bits |
| oplen_t | opcode; | // encoded opcode |
| string | syntax; | // disassembled opcode |

The instruction generator fills in these fields with the values appropriate to the solution instruction, thus returning the solution instruction's length, encoding, and disassembled form to the user. In order to generate an instruction, the user must declare a VmlInstruction object, and must call its ‘Generate’ method:

VmlInstruction instr(“Random instruction”);
instr.Generate( );// ‘instr’ now contains a random instruction

A text string is supplied to the VmlInstruction constructor for debug and logging purposes. In the absence of any constraints, the ‘Generate’ method will randomly set ‘instr’ to one of the 12 listed instructions for this target processor. In order to narrow the selection, it is necessary to set constraints for the generator. The ‘Keep’, ‘Keepin’, ‘KeepOut’, and ‘Select’ methods are provided for this purpose. The syntax of these methods is necessarily complex because of the requirements of the C++ language. However, in an alternative embodiment, the syntax can be simplified by the use of an appropriate preprocessor.

Listing 6 is an example of the use of the ‘KeepIn’ method:

Listing 6

| | |
|---|---|
| VmlInstrName ADDSUB(“Arith.AddSub”); | // all AddSub instrns |
| VmlInstrName OR (“Arith.Logic.OR”); | // the OR instruction |

VmlInstruction instr2(“A random instruction”);
instr2.KeepIn(2, VmlCnsWV(&ADDSUB)( ), VmlCnsWV(&OR)( ));
instr2.Generate( );

The ‘KeepIn’ method requires the initial ‘2’ parameter because the C++language does not have a general mechanism for passing variable-length argument lists; the ‘2’ parameter informs the C++ API that there are two further parameters in the function call. Instruction constraint method calls require a specification of a node or leaf location on the name tree of FIG. 8; in this example, the KeepIn call is passed node ADDSUB and leaf OR. These locations must be specified as objects of the VmlInstrName class. The ADDSUB object, for example, is declared as being the node “Arith.AddSub”.

When solving the KeepIn constraint, the instruction generator finds all leaves at, or descended from, the VmlInstrName parameters to the KeepIn call. For this example, the solution is composed of ADC 93, SBC 94, and OR 95. The generator then selects one of these three instructions, with an equal probability, and returns it in ‘instr2’.

The effect of Listing 6 may be alternatively achieved by using the ‘KeepOut’ method rather than ‘KeepIn’, to instruct the generator not to generate specified instructions. Listing 7 uses the ‘KeepOut’ method to generate one of ADC 93, SBC 94, or OR 95:

Listing 7

| VmlInstrName BRANCH (“Branch”); | | // all Branch instructions |
|---|---|---|
| VmlInstrName LDST | (“LdSt”); | // all LdSt instructions |
| VmlInstrName RTE | (“RTE”); | // the RTE instruction |

| | |
|---|---|
| VmlInstrName AND | (“Arith.Logic.AND”); // the AND instrn |

VmlInstruction instr3(“A random instruction”);
instr3.KeepOut(4, VmlCnsWV(&BRANCH)( ),VmlCnsWV(&LDST)( ),
VmlCnsWV(&RTE)( ), VmlCnsWV(&AND)( ));
instr3.Generate( );

The ‘Select’ method has a similar function to the ‘KeepIn’ method, but additionally allows the relative probabilities of different selections to be specified. The ‘Keepin’ example of Listing 6 could instead be coded using the ‘Select’ method as follows:

Listing 8

| | |
|---|---|
| VmlInstrName ADDSUB(“Arith.AddSub”); | // all AddSub instrns |
| VmlInstrName OR (“Arith.Logic.OR”); | // the OR instrn |

VmlInstruction instr4(“A random instruction”);
instr4.Select(2, VmlCnsWV(2, &ADDSUB)( ), VmlCnsWV(1, &OR)( ));
instr4.Generate( );

The ‘Select’ method in this example ensures that a subsequent ‘Generate’ statement will produce an ADDSUB instruction (in other words, an “Arith.AddSub”) with a relative probability of 2, and an OR instruction (in other words, “Arith.Logic.OR”) with a relative probability of 1. The relative probability is given by the first parameter to the VmlCnsWV constructor. Since there are two ADDSUB instructions, this Select statement will constrain the generator to produce one of three instructions, each with a probability of ⅓.

The instruction selection process can be refined by setting constraints based on instruction properties. Listing 9 below is a simple example which selects an instruction based on both its position within the name tree and its ‘mode’ property, and is also an example of the ‘Keep’ constraint:

Listing 9

| | |
|---|---|
| VmlInstruction | Instr5(“A random instruction”); |
| VmlGenInt | IMode(“mode”); |
| VmlInstrName | LDST(“LdSt”); // all LdSt instructions |

Keep(Instr5 == LDST);
Instr5.Keep(IMode != SVC);
Instr5.Generate( );

In order to constrain a property, that property must first be represented as an object of the VmlGenInt class. Listing 9 declares an IMode object which is set to the ‘mode’ property. The statement “Instr5.Keep(IMode!=SVC)” constrains Instr5 so that it will not be an SVC-mode instruction. The instruction generator therefore selects one of the three “LdSt” instructions which do not have the SVC mode, giving each a generation probability of ⅓.

If the instruction generator selects an instruction which does not have any declared fields, then it can encode that instruction simply by using the ‘decode include’ and ‘decode exclude’ specifications from that instruction's declaration. In this case, instruction generation has completed, and the selected instruction is returned. However, most instructions will include fields which must be set to specific values in order to fully encode that instruction. If these fields are not constrained, then they will be generated randomly. If the generator selects the ADC instruction, for example, then the specific instruction generated might be ‘ADC R1,R4,R5’, or ‘ADC R2,R1,R7’. Each of the ‘Rd’, Ra’, and ‘Rb’ fields of this instruction are defined as 3-bit quantities, and the generator will independently generate each field, giving all possible values an equal weighting.

The generator may be prevented from assigning specific values to a field by using a ‘decode exclude’ specification. The ADC instruction of Listing 18, for example, includes the statement:
exclude Rd 0;

For this instruction, the generator will select only registers R1 through R7 for Rd, and all of R0 through R7 for Ra and Rb, giving a total of 448 (7*8*8) potential encodings of the ADC instruction. The ‘decode exclude’ specification is useful for architectures where part of one instruction's decode space is re-used by another instruction. In some architectures, for example, register R0 is not a general-purpose register, but instead has the fixed value ‘0’. In these architectures, R0 should not be specified as a destination register.

The user may specify more general constraints on field generation by using additional overloaded ‘Keep’, ‘KeepIn’, ‘KeepOut’, and ‘Select’ methods. These field constraint methods have a similar syntax to the corresponding instruction constraint methods, but they are instead applied to a ‘VmlGenInt’ object, rather than a ‘VmlInstruction’ object. The user may also use ‘VmlGenInt’ objects in order to declare, constrain, and generate arbitrary integers, as well as instruction properties and fields.

Listing 10 below is an example of the use of these constraints.

Listing 10

| | | | |
|---|---|---|---|
| 1 | VmlInstrName | ARITH (“Arith”); | // all Arith instrns |
| 2 | VmlInstrName | ADDSUB(“Arith.AddSub”); | // all AddSub instrns |
| 3 | VmlGenInt | DRa(ARITH, “Ra”); | // constructor type 5 |
| 4 | VmlGenInt | DRb(ADDSUB,“Rb”); | // constructor type 5 |

| | | |
|---|---|---|
| 5 | VmlGenInt | DRd(“Arith.AddSub.ADC.Rd”); // ctor type 3 |

| | |
|---|---|
| 6 | VmlInstruction instr6(“A random instruction”); |
| 7 | Keep(instr6 == ARITH); |
| 8 | instr6.KeepIn(DRa, 2, VmlCnsWV(2)( ) , VmlCnsWV(5,7)( )); |
| 9 | instr6.Select( |
| | DRb, 2, VmlCnsWV(1, 4)( ) , VmlCnsWV(4, 6)( )); |
| 10 | instr6.Keep(DRd < 3); |
| 11 | for(int i=0; i<4000; i++) |
| 12 | instr6.Generate( ); |
| 13 | VML_log(0, false, “%s”, instr6.Profile( ).c_str( )); |

When used to constrain an instruction field, a ‘VmlGenInt’ object must first be associated with a specific instruction or group of instructions (in other words, either a leaf or a node in the name tree) by specifying the instruction(s) and the field in the constructor. Lines 3 and 5 show two alternative mechanisms for doing this. Line 3 creates an object named ‘DRa’, which may be used to constrain the ‘Ra’ field of any of the four instructions in the ‘Arith’ node. At least one of these four instructions should actually declare an ‘Ra’ field; if more than one of these instructions declares an ‘Ra’ field, then those fields should all have the same size. For this example, all four instructions have a 3-bit ‘Ra’ field. Line 5 creates an object named ‘DRd’. The DRd constructor in this case directly names the ‘Rd’ field of the ‘Arith.AddSub.ADC’ instruction, and the ‘DRd’ object may be used to constrain the ‘Rd’ field of only this one instruction.

Line 7 constrains ‘instr6’ such that it will always be one of the four instructions in the ‘Arith’ node; these are ADC 93, SBC 94, OR 95, and AND 96. Each instruction will be given a generation probability of ¼. When the generator has selected an instruction, it then attempts to solve the field constraints on that instruction. The field constraints are set, using various alternative mechanisms, on lines 8, 9, and 10, as described below.

Line 8 specifies that the ‘Ra’ field of any Arith 92 instruction should be in the range [2,5 . . . 7]. This range includes the four integers 2, 5, 6, and 7; each of these integers will be given a generation probability of ¼.

Line 9 specifies that the ‘Rb’ field of any instruction in the ‘Arith.AddSub’ node should be given a selective weighting. However, the instructions OR 95 and AND 96 are not in this node. If one of these instructions is selected, then this field constraint is ignored, and the ‘Rb’ field is set randomly, giving all 8 potential values an equal probability. On the other hand, ADC 93 and SBC 94 are both in the ‘Arith.AddSub’ node. If either of these instructions is selected, then the ‘Rb’ field will be set to 4 with a probability of 20% (⅕), or will be set to 6 with a probability of 80% (⅘).

Line 10 specifies that the ‘Rd’ field of ADC 93 must be set to a value which is less than 3. If the generated instruction is not ADC 93, then this constraint will be ignored. However, if the generated instruction is ADC 93, then the ‘Rd’ field will be set to either ‘1’ or ‘2’ (the value ‘0’ is excluded by the ‘decode exclude’ specification of Listing 18).

Table 8, Table 9, and Table 10 summarise the results of the ‘Generate’ operation on line 12 of the code. The ‘Generate’ method in this example is called 4000 times, and the tables show the ideal distributions of the values of the ‘Ra’, ‘Rb’, and ‘Rd’ fields. The values shown give the ideal number of ‘hits’ for that combination. For example, if the ‘Generate’ method is called 4000 times for this set of constraints, then an ADC 93 instruction in which ‘Ra’ is equal to 2 would be expected to be produced on 250 occasions. In practice, the actual values displayed by the ‘Profile’ and ‘VML_log’ calls of line 13 are likely to be slightly different from these values. The differences will be due to the specific implementation of the pseudo-random number generator, and the specific value of the master seed supplied to the test harness.

TABLE 8
Ra distribution

| | 0 | 1 | 2 | 3 | 4 | 5 | 6 | 7 | Total |
|---|---|---|---|---|---|---|---|---|---|
| ADC | 0 | 0 | 250 | 0 | 0 | 250 | 250 | 250 | 1000 |
| SBC | 0 | 0 | 250 | 0 | 0 | 250 | 250 | 250 | 1000 |
| OR | 0 | 0 | 250 | 0 | 0 | 250 | 250 | 250 | 1000 |
| AND | 0 | 0 | 250 | 0 | 0 | 250 | 250 | 250 | 1000 |

TABLE 9
Rb distribution

| | 0 | 1 | 2 | 3 | 4 | 5 | 6 | 7 | Total |
|---|---|---|---|---|---|---|---|---|---|
| ADC | 0 | 0 | 0 | 0 | 200 | 0 | 800 | 0 | 1000 |
| SBC | 0 | 0 | 0 | 0 | 200 | 0 | 800 | 0 | 1000 |
| OR | 125 | 125 | 125 | 125 | 125 | 125 | 125 | 125 | 1000 |
| AND | 125 | 125 | 125 | 125 | 125 | 125 | 125 | 125 | 1000 |

TABLE 10
Rd distribution

| | 0 | 1 | 2 | 3 | 4 | 5 | 6 | 7 | Total |
|---|---|---|---|---|---|---|---|---|---|
| ADC | 0 | 500 | 500 | 0 | 0 | 0 | 0 | 0 | 1000 |
| SBC | 125 | 125 | 125 | 125 | 125 | 125 | 125 | 125 | 1000 |
| OR | 125 | 125 | 125 | 125 | 125 | 125 | 125 | 125 | 1000 |
| AND | 125 | 125 | 125 | 125 | 125 | 125 | 125 | 125 | 1000 |

For the example of Listing 10, the ‘Ra’, ‘Rb’, and ‘Rd’ fields are generated independently, so as not to overcomplicate the example. Constraints may alternatively be specified in terms of other generatable objects in order to make generatable items dependent upon each other. For example, the constraint
instr6.Keep(DRd<DRb);

instructs the generator to keep the value of the ‘Rd’ field less than the value of the ‘Rb’ field.

A preferred embodiment for the solution of constraints involving dependent variables requires the use of Integer Linear Programming Techniques. These techniques are well documented in the literature. Alternative embodiments may involve heuristic approaches, involving trial and error.

To take full advantage of dynamic simulation, the user must be able to retrieve information concerning the current state of the simulation. If, for example, the processor has different modes of execution and is currently in a ‘user’ mode, then instruction generation may be constrained so as not to produce supervisor-mode or exception-mode instructions. Without this flexibility, it will in general be impossible for the user to create pseudo-random programs which are also legal programs for the target processor.

The user may retrieve the current state of the simulation by calling appropriate routines in the test harness API interface (API Interface 15 of FIG. 1). These routines are shown in Listing 11, as C++ prototypes.

Listing 11

```
uint64_t VML_byte_read(
  string name, uint64_t address = 0, int *errcode = 0);
uint64_t VML_word_read(
  string name, uint64_t address = 0, int *errcode = 0);
uint64_t VML_imem_free(uint64_t addr);
```

The ‘VML_byte_read’ and ‘VML_word_read’ routines may be called by the user to retrieve information on the current state of the simulation. The ‘name’ parameter must be the declared name of a region; it may be, for example, “Status”, “Data”, “Opc”, or “PC” for a VML description that includes Listing 14, Listing 15, and Listing 16. If the named region has only a single location (as is the case for “Status”, “Opc”, and “PC”) then the address parameter may be omitted.

The ‘VML_imem_free’ method returns the amount of free space in the instruction memory, starting from address ‘addr’. This routine is primarily required by the user when it is necessary to generate a branch instruction, to confirm that there will be enough memory at the branch destination to carry on generating instructions when the branch has completed.

In a dynamic simulation, the user is responsible for creating instruction “scenarios” which are to be executed by the test harness. The test harness requests a new scenario from the user when it attempts to fetch an area of instruction memory which has not yet been initialized, and it then loads the returned scenario into instruction memory. In a preferred embodiment the scenario will remain in instruction memory until the simulation finishes. In an alternative embodiment of dynamic simulation, the test harness deletes an instruction scenario from instruction memory when it has completed execution of that scenario. This ensures that instruction memory does not fill up as simulation progresses.

In a static simulation, by contrast, the test harness simply locates an executable program, and loads it into memory before starting the simulation.

A scenario is a sequence of instructions that together perform some useful action. Creating and verifying scenarios can exercise specific parts of a design far more effectively than simply verifying single random instructions. A scenario might, for example, be created from an instruction which loads a counter register, followed by a random number of arithmetic instructions, followed by an instruction which decrements the count register, and branches back to the start of the arithmetic instructions if the count register is non-zero.

If a dynamic simulation is required, the user must write a scenario generator routine and must supply the address of this routine to the test harness during initialization. In order to initialize the test harness, the user calls the ‘VML_sim_init’ routine of the API interface, which has this C++ prototype:

int VML_sim_init(
const VmlSimParams &vsp, int &argc, char** (&argv));

The user passes in as the first parameter a reference to a ‘VmlSimParams’ structure. One of the fields in this structure is the ‘scf’ member, which the user must set to the address of a “scenario generation” function. The test harness will automatically call this function when it attempts to fetch and execute an address in instruction memory which has not yet been initialized. The ‘scf’ member has a type of ‘VmlScenarioFunc’, which is:

typedef const VmlInstrVec& (*VmlScenarioFunc)(
uint64_t addr, uint64_t free);

in other words, the scenario generator function must take two parameters, ‘addr’ and ‘free’, and must return a reference to a ‘VmlInstrVec’. A ‘VmlInstrVec’ is simply an STL vector of VmlInstructions. The ‘addr’ parameter is the address at which the test harness will load the new scenario in instruction memory. The user may require this address in order to correctly generate some instructions, such as branches or PC-relative loads. The ‘free’ parameter is provided by the test harness to inform the user of how much free memory is available at this address; the user should not generate a scenario that extends beyond the available memory. The user's scenario generator creates the new scenario by declaring, constraining, and generating VmlInstructions as described above, and returning a vector of these VmlInstructions to the test harness. The user may return a single instruction, if desired, or may return a zero-length vector to terminate simulation.

In a preferred embodiment of the invention, the ISA specification is compiled whenever it is needed, by a Just-In-Time (JIT) compiler. This embodiment is described below. It will be apparent to those skilled in the art that there are other alternative embodiments which may be used to achieve the same effect.

The present invention includes a number of computer software products, or ‘tools’, which may be used to facilitate the development of a new processor, or which may be used when developing software for an existing processor. These tools include a test harness, a simulator, an assembler, and a disassembler. The tools also include a program which will create an HDL decoder, and a program which will create a back-end module for a compiler.

These tools are generic, in the sense that they are not customized for a particular processor. Exactly the same simulator, for example, may be used to simulate a Pentium™ processor, an ARM™ processor, or a PowerPC™ processor.

This flexibility is made possible because these tools, as part of their initial processing, read in and analyze the ISA specification of the required ‘target’ processor. The tool then tailors its actions according to the characteristics of the target processor. The user of the invention specifies the required target processor by giving the filename of the required ISA specification as either a command-line parameter, or as an environment variable.

When the tool is run, it executes the VML compiler, which reads the required ISA specification. The specification is pre-processed using the standard ‘C’ preprocessor, ‘cpp’. The preprocessor output is stored in a temporary file, and is then compiled using a JIT technique. The compiled specification is returned to the tool in the form of an Intermediate Representation (IR), which is not dependent on the target processor. The tool itself therefore does not have to deal with the intricacies of a particular target processor, and is therefore generic.

The ‘action specification’ of an opcode or exception declaration in the ISA specification gives a list of actions which must be executed to simulate the effect of that opcode, or exception. The JIT compiler translates the action specification into an IR representation, as it does for all other sections and specifications. When it is necessary for a tool to carry out a simulation, the tool interprets the translated action specification at runtime. In an alternative embodiment, the compiler translates the action specification directly into machine code for the host processor, thus speeding up simulation.

In a preferred embodiment of the present invention, the ISA specification is written in the VML language. The VML language is summarized below, and is documented in detail in “Technical Specification: VML Language Specification, document VML-0001”. It will be apparent to those skilled in the art that the ISA specification could be written in alternative languages, to achieve the same effect.

An ISA specification written in the VML language is primarily composed of a set of declarations, and a set of operation descriptions, or ‘actions’. Actions are written in a straightforward procedural style, which is intended to be immediately familiar to anyone who has any experience of ‘C’, or similar languages. These declarations and actions effectively form an executable specification for the processor, in exactly the same way that the Architecture Reference Manual is itself a written specification for the processor.

A VML model is made up of a number of sections, including decode, property, region, exception, function, encoding, and opcode sections. All sections, apart from the opcode, function, and encoding sections, are declarative sections that declare some property of the processor, or its ISA. Each of the processor's instructions is described in a single opcode section. An opcode section is further sub-divided into a number of specifications, including decode, property, field, action, compiler, and format specifications. These specifications describe some aspect of the instruction itself. A complete VML model is made up of a VML grammar statement, which identifies the model, and which is followed by any number of the sections described above. The sections may occur in any order. A VML model includes executable code in the exception, opcode, and function sections. This executable code forms a series of steps which must be followed in order to emulate the operation of either an exception, or an instruction, or to assemble and disassemble an instruction. These steps are termed actions. In a written ISA specification, it is common to include ‘pseudo-code’ which describes exceptions and instructions. The actions of a VML model are exactly analogous to this pseudo-code. This allows a VML model to be viewed as an ‘executable specification’ of a processor's ISA. The syntax of VML actions is, in many respects, similar to the syntax of the popular ‘C’ programming language. However, the C-related syntax has been simplified, and in some cases extended, and VML also has many extensions to handle the hardware-related nature of ISA specifications. These extensions include assertion and reporting statements, bit selections, wait statements to describe multi-phase instructions, blocking and non-blocking assignments, specifications of instruction interrupt points, memory locking, flag operations, arithmetic extensions, sign-extension, and general N-bit arithmetic. These extensions exist to allow the simple modelling of a wide variety of processors, including processors with exposed pipelines, processors with instruction sets that include long interruptible operations and delayed operations, and processors with arbitrarily-sized registers and memory words.

Executable VML code consists of functions. Top-level functions are introduced by the action and format keywords, and may be found in exception and opcode sections; these functions are effectively ‘main’ functions. The term ‘function’ is therefore used generally to describe an action specification in an exception or opcode section, as well as functions which are explicitly declared in a function section.

VML comments use the same syntax as C++, and may appear anywhere in a description. VML action code must be terminated with a semicolon. Any other VML code may be optionally semicolon-terminated, if desired.

The C preprocessor, cpp, is run as the first stage of compilation. VML models may therefore be arbitrarily pre-processed.

The sections below describe the individual parts of a VML description.

The decode section is optional, and is only required if it is necessary to create an HDL decoder from the ISA specification. The decode section is used to declare any HDL signals which may be named in the decode specification of a subsequent opcode section. Any number of decode sections may be present, and the signal information for those sections will be collated.

A decode section may optionally include prefix and suffix statements. These statements provide a text string which will be used as a prefix, and as a suffix, for any signals which appear in the HDL output. In Listing 12, for example, the ‘UpdateCC’ signal will actually appear in the generated HDL code as ‘VXDecUpdateCC_’. This feature allows a compact name to appear in the VML description, which will be expanded to a complete HDL name in the HDL source.

A decode section names the required signals, and also provides the allowable range for those signals. The declaration of RsrcA below, for example, includes a range declaration of [0 . . . 7]. This states that the ‘VXDecRsrcA_’ signal will only take on values in the range [0 . . . 7]. This is used in the VML description for error checking, and will allow a synthesizer to infer a 3-bit signal when synthesizing the generated decoder.

Listing 12 below is a simple example of a ‘decode’ section within a VML description.

Listing 12

decode {

| prefix VXDec; | |
|---|---|
| suffix _; | |
| signal UpdateCC, WriteRegs, BrAbs, BrRel; | |
| signal RsrcA[0..7], RsrcB[0..7], Rdst[0..7]; | |
| signal Latency[1..8] = 1; | // default 1-cycle latency |
| signal Immed8 [((1<<8)−1)..0]; | // 8-bit immediates |
| signal Immed16[((1<<16)−1)..0]; | // 16-bit immediates |
| signal Immed24[((1<<24)−1)..0]; | // 24-bit immediates |
| signal AluOp [0..15]; | // ALU operations |
| signal FnuType[0..8]; | // required function unit |

}

A property section is used to declare global properties, or attributes, of the instruction set. The example property section below declares the length property, which has a predefined meaning. The length statement declares that this instruction set includes opcodes which may be either 8, 16, 24, or 32 bits long. A property section may include any number of user-defined properties; the example below includes a single user-defined property, named ‘mode’. This statement allows the user to supply constraints to the instruction generator in terms of this ‘mode’ property. The user may request, for example, that a generated instruction should have a 10% probability of being a USR-mode instruction, and a 90% probability of being an SVC-mode instruction. Individual opcode sections may include a property specification, which specifies which particular properties that opcode has. An RTI opcode which is used to return from an interrupt might, for example, declare that it has the INTR property.

Listing 13

| property { | |
|---|---|
| length: | |
| range [8,16,24,32], | // can have 1, 2, 3 and 4-byte opcodes |
| default 32; | // the default is 32 bits |
| mode: | |
| range [USR, SVC, INTR], | |
| default USR; | // instructions default to user mode |
| } | |

A region section is used to declare any memory resources which are accessed in the VML description. The declaration provides a name which may be used in action code; for example, the action ‘GPR[0]=1’ requires a declared memory region named ‘GPR’. The region declaration defines the characteristics of that memory region, which allows the test harness to create any memory required for simulation.

The HDL code may itself also access memory within the test harness, for two reasons. The first of these is that the processor model, and any associated BFMs, may use the test harness to implement the required memory, rather than implementing it themselves. The second reason is that the processor model, and any associated BFMs, must access memory within the test harness in order to carry out verification. The HDL code accesses this memory using notifications to the API interface of the test harness. Most HDLs are relatively unsophisticated, and may not be able to access a memory region by its declared name. For this reason, the region declaration also includes an integer ‘handle’ which the HDL code may use to access that region. If it necessary for a memory region to be accessed by the HDL code, then that memory region should have one or more of the attributes documented in Table 6.

A VML description requires two pre-defined regions, which have the opcode and PC attributes. These regions are required for correct operation of the simulator, but are not generally required by HDL code (since most processor models will not have easily-identifiable instruction decode and PC registers). These regions will not require a handle declaration if they are not accessed by the HDL code; their purpose is to inform the instruction level simulator of the size and indexing of a nominal instruction decode register and a nominal program counter. The opcode region declaration may also include a specification of a decoder which derives the instruction length for a variable-length instruction set; an example of such a specification is given in Listing 16 below. If this specification is present, it overrides any use of the predefined length property.

Listing 14 below is the region declaration for a simple 6-bit status register. This declaration includes a number of items of interest. The keywords register and memory may be used to introduce a region section; both keywords are equivalent. This region has been given the name ‘Status’, and has a corresponding integer handle of ‘HANDLE_STATUS’ (where the value of HANDLE_STATUS might, for example, be supplied by an include file which is shared between the VML description and the HDL source). The type statement gives any attributes of this memory region; in this case, the checked keyword states that any HDL writes to this region must be verified by the test harness. The index statement declares that this is a 6-bit register, with bit 5 on the left, and bit 0 on the right. In general, the left and right indices may have any value, with the difference between them giving the size of the register or memory word. The word address statement declares that this region is word-addressable, and contains only one word. Finally, this section declares a number of global fields, which may be used elsewhere in the VML description as short-hand names for particular bit fields within this register. The name ‘ZF’, for example, may be used equivalently to the full specification of ‘Status.(1)’.

Listing 14

```
register Status (HANDLE_STATUS) {
  type checked;
  index 5..0;
  word address;
  // global field declarations:
    field NF(0), ZF(1), CF(2), VF(3), CC(4), IEN(5);
}
```

As a second example, Listing 15 below is the region declaration for a 4 Kbyte data memory. The memory may be referred to in action code using the name ‘Data’, and in HDL code using the integer handle ‘HANDLE_DATA’. The memory is composed of 32-bit words, indexed from bit 31 on the left to bit 0 on the right. The memory is defined as being byte-addressable, with a low address of 0, and a high address of 4095.

Listing 15

memory Data (HANDLE_DATA) {

type shared, checked;
index 31..0;
byte address 0..((1 << 12)−1);

}

Listing 16 below is an example declaration for both the opcode and PC regions. The opcode attribute defines the ‘Opc’ region as being the nominal instruction decode register. This is defined as a 32-bit register, with bit 1 on the left, and bit 32 on the right. The left align attribute states that the variable-length instructions are left-aligned within this register before being decoded. The PC attribute identifies the ‘PC’ region as being the nominal program counter. Following this declaration, the ‘PC’ name may be read, or assigned to, within action code, and this will be equivalent to reading or writing the program counter.

Listing 16

```
register Opc { // defaults to ‘word address’
  type opcode, left align;
  index 1..32;
  // an example of a variable-length instruction decoder,
  // with a default length of 32 bits
  decode OpcodeLength =
    (Opc & 0xc000_0000) == 0x0000_0000? 8 :
    (Opc & 0xc000_0000) == 0x4000_0000? 16 :
    (Opc & 0xc000_0000) == 0x8000_0000? 24 : 32;
}
register PC {
  type PC;
  word address;
  index 31..0;
}
```

An exception section is used to declare the properties and effect of any exceptions which may either be externally applied to the processor, or which may internally arise as a result of the execution of a program. An exception is named, and also has an integer handle which may be used by the HDL code when raising notifications to the test harness. Listing 17 is an example of an exception declaration. This declares an exception named ‘Intr2’, with a handle of ‘HANDLE_INTR2’. An exception declaration includes a property specification, and an action specification. The syntax of the action specification is identical to that of the action specification within an opcode section.

The property specification includes a list of pre-defined properties, which describe the exception. These properties are listed in Table 11 below.

TABLE 11

| Property | Purpose |
|---|---|
| serialise | Declares a serialising exception. |
| abort | Declares an aborting exception. These exceptions take effect |
| | immediately, and abort the execution of any instructions in progress. |
| priority | The integer priority of this exception, with respect to all other |
| | declared exceptions. The highest priority is ‘1’, with higher numbers |
| | corresponding to lower priorities. |
| enable | The enable condition for the exception, if it has one. The enable |
| | condition should be the name of a global field, followed by the level |
| | (0 or 1) which enables the exception. Listing 14, which is a region |
| | declaration for a status register, includes an example of a global field |
| | named ‘IEN’. |
| FetchAbort | Declares the exception which will be taken if an abort occurs during |
| | an instruction fetch. |
| DataAbort | Declares the exception which will be taken if an abort occurs during a |
| | data read or write. |
| UndefinedInstruction | Declares the exception which will be taken if an undefined instruction |
| | is encountered. |

Listing 17

```
exception Intr2 (HANDLE_INTR2) {
  property serialise, priority 4;
  property enable IEN 1;
  action {
    A[7] = PC; // save the PC, and branch to 0x60
    PC = 0x60;
  }
}
```

Each of the processor's instructions is described in an opcode section. An opcode section has several purposes, including naming the instruction, defining various attributes of the instruction, specifying how the instruction should be decoded, specifying how the instruction can be used by a compiler, specifying the actions to be taken when the instruction is executed, and specifying the syntax of the instruction. Listing 18 below is an example of the declaration of an ‘Add with carry’ instruction, which adds the contents of two registers, and writes the results to a third register.

Listing 18

```
/* ADC Rd,Ra,Rb
* src: register
* dst: register */
opcode Arith.AddSub.ADC {
  property length 16;
  field {
    Rd( 8:10);
    Ra(11:13);
    Rb(14:16);
  }
  decode {
    signal UpdateCC, WriteRegs, RsrcA=Ra, RsrcB=Rb, Rdst=Rd,
      FnuType=AU, AluOp=ADDC;
    include 0xfe00, 0x9800;
    exclude Rd 0;
  }
  action {
    R[Rd] = R[Ra] + R[Rb] + CF;
    CF = _CFlag; // CF is a global flag in a status register
    VF = _VFlag; // _VFlag is a predefined VML variable
    NF = _NFlag;
  ZF = _ZFlag;
  }
  format ‘ADC R%d, R%d, R%d’, Rd, Ra, Rb;
}
```

This instruction is given the hierarchical name ‘Arith.AddSub.ADC’. The hierarchical name is used by the instruction generator to identify either this specific instruction, or a group of instructions at any node in the name tree. The generator might be constrained to produce only ‘Arith’ instructions, for example, in which case instructions will be selected from any which have a name on the ‘Arith’ branch of the name tree.

The property specification gives the properties of this instruction, selected from the global properties defined in the property section. Listing 13 is an example property section, which includes the length property. The length declaration in this opcode states that this is a 16-bit opcode.

The field specification defines short-hand names for any fields within the current instruction. The field ‘Rd’, for example, is defined as being bits 8 to 10 of the current instruction. With the example opcode register declaration of Listing 16, ‘Rd’ is equivalent to the full form of ‘Opc.(8:10)’. The instruction generator will also create pseudo-random values for declared fields, according to specified constraints.

The decode specification has two purposes. The first purpose is to define how this instruction may be decoded, using the include and exclude keywords. For this example, an instruction is an ‘Arith.AddSub.ADC’ if the relationship ((instruction & 0×fe00)==0×9800) is true, and if the ‘Rd’ field does not contain the value ‘0’. The second purpose of the decode specification is to inform the HDL decode generator of the signals which should be set when this instruction is decoded. Listing 12 above showed an example decode section, which declared the signals which could be set in subsequent opcode declarations. ‘RsrcA’, for example, was declared as a 3-bit signal. The decode specification of the ‘Arith.AddSub.ADC’ instruction states that, if this instruction is decoded, ‘RsrcA’ (or, to be precise, ‘VXDecRsrcA_’) should be set to the contents of the ‘Ra’ field.

Listing 19 shows a part of the output of the HDL decode generator, for the ‘VXDecRsrcA_’ signal of a similar processor. For this example, the output was generated in the C++ language, for use with a SystemC synthesizer.

Listing 19

| | |
|---|---|
| VXDecRsrcA_{—} = | |
| (((Opcode & 0xfe000000) == 0xc8000000))? | |
| ((Opcode & 0x00380000) >> 19) : | // Arith.ADC |
| (((Opcode & 0xfe000000) == 0xd0000000))? | |
| ((Opcode & 0x00380000) >> 19) : | // Arith.SBC |
| (((Opcode & 0xfe000000) == 0xd8000000) && | |
| ((Opcode & 0x01c00000) != 0x00000000))? | |
| ((Opcode & 0x00380000) >> 19) : | // Arith.OR |
| (((Opcode & 0xfe000000) == 0xe0000000) && | |
| ((Opcode & 0x01c00000) != 0x00000000) && | // Arith.AND.Rd != 0 |
| ((Opcode & 0x01c00000) != 0x01000000) && | // Arith.AND.Rd != 4 |
| ((Opcode & 0x01c00000) != 0x01400000) && | // Arith.AND.Rd != 5 |
| ((Opcode & 0x01c00000) != 0x01800000))? | |
| ((Opcode & 0x00380000) >> 19) : 0; | // Arith.AND |

The format specification provides a template for assembling and disassembling this instruction. The template is essentially equivalent to the well-known ‘printf’ and ‘scanf’ statements of the C language, with some extensions to allow conversion between strings and integers, and to allow action code to be executed to handle complex conversions.

The compiler specification provides instructions for the use of this opcode by a compiler. The syntax of the specification depends on the target compiler; the compiler back-end generator collates the compiler statements for all opcode sections, and combines them with an additional ABI specification, to produce the back-end files necessary to re-target a particular compiler.

An action specification defines the actions which are taken either when a specific instruction is executed, or when an exception is acted on. Action specifications may appear in exception sections and opcode sections. Action specifications have a syntax which is a simplified version of the ‘C’ language, with various hardware-related extensions. The action code for a particular opcode may be a single statement, or multiple statements enclosed in braces. Examples of single-statement action specifications include

```
action
  if(ZF) // see Listing 14
    PC = R[Ra];
```

which carries out a register-indirect branch if the ‘ZF’ flag is set, or
action R[Rd]=R[Ra];

which moves one register to a second register. Action specifications will rarely contain more than 20 or so statements. Action specifications give a sequence of logical operations which must be performed in order to achieve the effect of the instruction.

An object is a named item in a VML model that has an associated value. There are several classes of object in a VML model, which include variables,fields, properties, and regions.

Variables are used to model algorithms which implement the behaviour of an instruction. Regions model hardware memory. Fields are bit fields within an opcode, and properties give the value of some property associated with the opcode.

The set of allowable values of an object is given by its type. The value of an object must be an integer, a fixed-point integer, or a floating-point number, where the allowable range of the object is specified in its declaration.

The value of a field or property is set either implicitly or in its declaration, and it may not be changed after that point. Objects of these classes are therefore readable, but not writeable.

Variables and regions are both readable and writeable. Objects of these classes can be modified only by assigning an expression to them. Variables should not be read before they have been assigned to, and any attempt to do so will generate a warning. Regions, however, are given default values, and they may be read without a prior assignment.

Objects are read in expressions. An expression may manipulate an object, or combine multiple objects, using operators. The resulting value of the expression may be written to a writeable object in an assignment statement.

The VML language provides both blocking assignments and non-blocking assignments, with the same semantics as the Verilog and VHDL languages. Any writeable object may be assigned to with either form of assignment. Blocking assignments use the normal ‘=’ syntax to specify that an assignment occurs immediately. Non-blocking assignments use the ‘:=’ syntax to specify that the assignment is deferred, and will take place when the instruction completes. Non-blocking assignments are necessary because the wait statement allows the execution of two or more instructions, or exceptions, simultaneously. Non-blocking assignments allow simultaneously-executing instructions to access common resources without race conditions.

VML code may generate output messages using the report statement. The report statement produces textual output which is added to the log file and which is optionally displayed. The syntax of the report statement is:
report ‘formatstring’ parameters;

where ‘formatstring’ is a printf-style format control string, and ‘parameters’ is a list of zero or more parameters, as required by the format control string.

VML also includes an assert statement, which may be used to carry out assertion checks. The syntax of the assert statement is:
assert condition [report_statement];

where ‘condition’ is a boolean condition which evaluates to either ‘true’ of ‘false’. If the condition evaluates to true, the statement is ignored. If the condition evaluates to false, however, an assertion error is generated, and an error message is added to the log file. The error message will be created from the optional ‘report’ statement, if it is present.

Any named object may be sliced by following the name with a bit select specification. The bit select specification contains a left and a right index, which must be within the range specified in that name's declaration. A bit select specification has the format ‘.(N:M)’, where ‘N’ is the left index of the required slice, and ‘M’ is the right index. The left index may optionally be preceded by a ‘#’ token, in which case the slice is sign-extended before use. A slice may only be sign-extended for read operations; it is not possible to write to a sign-extended slice.

The ‘Data’ region of Listing 15, for example, specifies a 32-bit word with bit 31 on the left, and bit 0 on the right. The name ‘Data[4]’ refers to be the 32-bit data at byte address 4 in this region. To access the low byte of this data, the name should be followed by ‘.(7:0)’:

// read the low byte of Data[4], assign to temp1
temp1 = Data[4].(7:0);
// read and sign-extend the low byte of Data[4]
temp2 = Data[4].(#7:0);
// write the high byte of Data[4] to the low byte
Data[4].(7:0) = Data[4].(31:24);

Wait statements are required when the execution of an instruction may overlap with the execution of another instruction. This will happen when the processor has exposed delay slots in, for example, delayed branch or delayed load instructions. Assume, for example, an ISA in which the result of a load instruction is not available to the programmer until the second following instruction:

| | |
|---|---|
| LD r0, [r1] | // load r0 with the memory data addressed by r1 |
| MOV r2, r0 | // moves the old value of r0 to r2 |
| MOV r3, r0 | // moves the new value of r0 to r3 |

The wait statement is required to model the delay between the initiation and the completion of the ‘LD’ instruction. The LD instruction might be coded in VML as follows:

| | |
|---|---|
| action { | |
| temp = *R[src]; | // read the memory data |
| wait 1; | // wait one ‘instruction’ |
| R[dst] := temp; | // runs in parallel with next instruction |
| } | |

The wait statement includes an integer parameter, which must be greater than zero, and which gives the number of instructions to wait. Note that the wait parameter does not specify the number of clock cycles to wait: VML is not concerned with clock cycles, but simply with instruction-level execution. The use of wait statements will result in parallel, rather than sequential, opcode execution.

An instruction's action code cannot, by default, be interrupted. This allows the easy modelling of processors for which serializing exceptions are acted on only when one instruction has completed, and the next instruction has not yet started. However, this can lead to a high interrupt latency in some circumstances. If an ISA includes a multi-word move instruction, for example, then it may be desirable to allow that instruction to be interrupted before it has completed operation. Similarly, it may be desirable to allow delayed load and delayed branch instructions to be interrupted. The waitintr statement is provided to allow these instructions to be modelled.

‘waitintr’ has the same semantics as ‘wait’, with the exception that waitintr is also an interrupt point. ‘waitintr’ is followed by an integer, which gives the number of instructions to wait, in the same way as for the ‘wait’ statement. This value may be zero for an instruction which does not overlap with any other instructions, but which must still be interruptible.

VML's arithmetic and logic operations are similar to C's, with the exception that operators are sized. 20 The operation size is determined by some combination of the properties of the operator itself, and its input operands, as defined by the Operation Sizing rules. This provides a hardware-centric view of arithmetic and logic operations, and simplifies the description of processor datapaths. A specialized processor might, for example, have 24-bit data registers, and an 18-bit adder. The following statement will carry out an 18-bit addition on two registers and write the result back to a third register:
R[2]=R[0]+$18 R[1];//0-extend 18-bit result to 24 bits

Both operators and operands may be signed, and the Extension rules determine how ‘signedness’ propagates through an expression. As a simple example, however, the result of an arithmetic operation may be sign-extended to the target register size by adding a ‘#’ token to the operator:
R[2]=R[0]+#$18 R[1];//sign-extend result to 24 bits

VML includes 4 predefined variables, with the names _CFlag, _VFlag, NFlag, and _ZFlag. These one-bit variables may be read, but not written, and are automatically set by arithmetic and logic operations. These variables correspond to the carry, overflow, negative (sign) and zero flags, respectively, for arithmetic and logic operations. _CFlag and _VFlag are set only by add and subtract operations; the remaining flags are set by all logic and arithmetic operations. Flag setting operations take into account the size of the operation involved. The ‘+$5’ operator, for example, defines a 5-bit adder; the carry flag resulting from the use of this operator represents the carry out of bit 4. An additional 4-bit variable, named _Flags, may be used to read or set all of _CFlag, _VFlag, _NFlag, and _ZFlag simultaneously.

The use of the flag and sized operator features allows the target processor's arithmetic and logic operations to be coded simply and efficiently. Listing 18 above, for instance, is a specification of an add-with-carry instruction, which requires only 5 lines of code for any size of adder. The instruction adds two registers, together with the existing value of the carry flag, and writes the result data into a third register, and the result flag values into various bits of a status register. The status register is declared in Listing 14.

It will be readily understood by those skilled in the art that the present invention may be implemented either in software or in hardware. If the invention is implemented in software then it will be apparent from the preceding discussion that an operating system supporting multi-threading is preferred. Otherwise, the invention may be implemented using any conventional work station, with the type of processor and/or operating system not being crucial to the working of the invention.

It will also be understood that code comprising the present invention may be supplied on computer-readable media, such as CDs DVDs or “firmware” such as PROMSs or EPROMs, or may be offered for down-loading across communications networks. The invention may also be implemented either partially or entirely using hardware. This includes the use of technologies such as FPGAs and ASICs, which may comprise some combination of both hardware and software.

Appendix A: Glossary

The following descriptions are provided for a number of terms used in this specification. Unless the context requires otherwise, the descriptions are to be understood to imply the inclusion of the broader meaning in understanding the terms, but not the exclusion of any other broader meaning evident from the context.

A “processor” is a device which may be used to execute algorithms by following sequences of instructions. In its most obvious form, a processor is a computer's Central Processing Unit (“CPU”). A processor may have a physical implementation, or it may be represented as a model. This model will normally be written in a Hardware Description Language (“HDL”).

The “Target Processor” is the processor that the user of the invention wishes to verify.

A “Hardware Description Language”, or HDL, is a computer language which may be used to represent, among other things, electronic systems. Any language may be used as an HDL, although electronic systems are more easily described with specialized HDLs such as Verilog and VHDL. Specialized HDLs are parallel, rather than sequential, and have a concept of time. Electronic systems described in an HDL may be simulated, to ensure that a physical representation of the circuit will work as expected, and they may be synthesized, to convert the model into a physical representation. HDL descriptions may be written at a number of different ‘abstraction levels’. At the lowest level, an HDL model may simply describe transistors and the connections between those transistors, together with timing information. At the highest level, an HDL model represents the behaviour of the system, rather than any specific implementation of that behaviour.

“Processor verification” is the procedure whereby it is confirmed whether or not a processor behaves according to its specification. Processor verification can be divided into the two procedures of “module verification” and “ISA verification”, where module verification is a low-level procedure which verifies the behaviour of individual components of the processor, and ISA verification is a high-level procedure which verifies the behaviour of the entire processor.

“Module verification” is defined here as the traditional process of creating a testbench, instantiating one or more modules of the HDL code within that testbench, driving the inputs of the module with known values, and verifying that the outputs of the module are as expected. This procedure is extensively documented in the prior art, and is generally called out by the designer of the HDL module, or by a verification engineer, to confirm that the module behaves according to its own individual specification.

“ISA verification” is defined here as the process of testing the entire processor HDL model by causing it to execute an instruction stream, or program. The system surrounding the processor provides the processor with an instruction, and it responds to any read or write requests issued by the processor. The system also provides additional inputs to the processor, such as synchronous or asynchronous resets and interrupts. The system surrounding the processor HDL model is composed of two elements: the “testbench”, and the “test harness”.

The “testbench” is defined here as the components required for module verification. These are low-level components that require knowledge of the module's ports. The testbench drives the module inputs, and it checks the module outputs. With reference to FIG. 1, the testbench can be seen to be composed of components Stimulus Generator 4, and Bus Functional Model(s) 8, 9.

The “test harness” is defined here as the additional software components required for ISA verification, over and above those required for module verification. These are high-level components that do not require knowledge of, or access to, the processor ports. With reference to FIG. 1, the test harness is component Test Harness 2.

1-18. (canceled)

19. A method of verifying a processor design against a processor specification, the method comprising:
a) creating a verification environment;
b) executing an instruction sequence in a first simulation process within the verification environment, the first simulation process comprising the execution of the instruction sequence according to a representation of the processor specification;
c) executing the instruction sequence in a second simulation process, the second simulation process comprising the execution of the instruction sequence according to a representation of the processor design; and
d) comparing results of the first simulation process with results of the second simulation process within the verification environment in order to verify the processor design,
wherein the representation of the processor specification is a machine-executable representation and the method further comprises processing the processor specification with a compiler to generate the machine-executable representation of the processor specification for the first simulation process.

20. A method according to claim 19, wherein the processor specification comprises one or more verifiable elements.

21. A method according to claim 20 wherein the verification environment maintains a current state of the one or more verifiable elements.

22. A method according to claim 19, wherein the processor specification further comprises at least one description of one or more instructions to be executed by the processor.

23. A method according to claim 22, wherein each said at least one instruction description comprises zero or more actions associated with the instruction.

24. A method according to claim 19, wherein the processor specification further comprises a description of a stimulus which may cause an exception condition in the processor.

25. A method according to claim 24, wherein said stimulus description comprises zero or more actions associated with the stimulus.

26. A method according to claim 25, further comprising executing actions associated with a stimulus, wherein zero or more entries are added to a specification queue.

27. A method according to claim 20, wherein each of the verifiable elements is associated with a respective specification queue, the method further comprising:
executing actions associated with one or more instructions from the instruction sequence within the first simulation, wherein zero or more entries are added to the specification queue.

28. A method according to claim 27, further comprising executing actions associated with a stimulus, wherein zero or more entries are added to a specification queue.

29. A method according to claim 20, wherein each of the verifiable elements is associated with a respective design queue.

30. A method according to claim 19, wherein the verification environment receives one or more notifications from the second simulation, the one or more notifications being generated by the operation of the second simulation.

31. A method according to claim 30 further comprising:
the verification environment analyzing the one or more received notifications; and
the verification environment generating one or more entries in one or more design queues in response to the received notifications.

32. A method according to claim 31, wherein the processor specification comprises one or more verifiable elements and each of the verifiable elements is associated with a respective specification queue, the method further comprising:
executing actions associated with one or more instructions from the instruction sequence within the first simulation, wherein zero or more entries are added to the specification queue; and
the verification environment verifying each verifiable element for which the design queue or the specification queue comprise one or more entries, by comparing the respective queues.

33. A method according to claim 32, wherein the verification environment:
identifies reconcilable entries within each queue; and
removes the reconcilable entries from the design queue and the specification queue and updates the state of the corresponding verifiable elements.

34. A method according to claim 32 wherein the verification environment reports an error if the design queue can not be reconciled with the compared specification queue.

35. A method according to claim 19, wherein the verification environment analyses the processor specification to determine a plurality of processor memory elements.

36. A method according to claim 35, wherein the verification environment further provides memory resources to the second simulation to implement the plurality of processor memory elements.

37. A computer-readable medium comprising code which, when executed causes a method according to claim 19 to be performed.
